(19) United States
(12) Patent Application Publication
(10) Pub. No.: US 2026/0196140 A1
(43) Pub. Date: Jul. 9, 2026

(54) SURGICAL TRAINING DEVICE WITH DIGITAL FEEDBACK AND AUGMENTED REALITY GUIDANCE

(71) Applicant: Cilag GmbH International, Zug (CH)

(72) Inventors: Sheri Carlon Tingom, Raritan, NJ (US); Clinton Davis, Raritan, NJ (US)

(73) Assignee: Cilag GmbH International, Zug (CH)

(21) Appl. No.: 19/381,849

(22) Filed: Nov. 6, 2025

Related U.S. Application Data
(60) Provisional application No. 63/716,593, filed on Nov. 5, 2024.

(51) Int. Cl. G09B 5/02; G06V 20/40; G06V 40/20; G09B 23/28; G09B 23/30

(52) U.S. Cl. CPC G09B 5/02; G06V 20/40; G06V 40/20; G09B 23/285; G09B 23/30

(57) ABSTRACT

A modular, ergonomic training system designed to teach and evaluate laparoscopic surgical skills through a collapsible frame featuring adjustable trocar ports that simulate real-world surgical scenarios for both right- and left-handed users. It includes a pegboard for attaching various training modules to practice tasks like object manipulation, precision cutting, and suture tying. The system integrates augmented reality (AR) and artificial intelligence (AI) for real-time, step-by-step guidance and performance analysis. AR overlays on a live video feed from a tablet mounted on the frame offer visual instructions, while AI algorithms evaluate metrics such as precision and technique, providing personalized feedback and automated skill assessment. Additional features include a rechargeable light source that mimics clinical lighting and reflective surfaces for enhanced performance monitoring. The system enables efficient, scalable training with cloud-based data storage for tracking progress, supporting remote coaching and long-term skill development.

### CROSS REFERENCE TO RELATED APPLICATIONS

This application claims the benefit of U.S. provisional application No. 63/716,593, filed on Nov. 5, 2024, which is incorporated by reference as if fully set forth.

### FIELD OF THE INVENTION

This invention pertains to the field of medical training devices, specifically those designed for minimally invasive surgical procedures. It integrates feedback with digital coaching through augmented reality (AR) and artificial intelligence (AI) to enhance surgical trainees'cognitive and psychomotor skills.

### BACKGROUND OF THE INVENTION

The Fundamentals of Laparoscopic Surgery (FLS) exam is a comprehensive educational and assessment program designed to teach and evaluate the essential cognitive and technical skills needed for performing laparoscopic surgery. It targets surgeons, residents, and other surgical practitioners to ensure a standardized level of proficiency in minimally invasive surgical techniques. The exam consists of two main components: a cognitive section and a skills section. The cognitive component assesses the candidate's understanding of laparoscopic surgical principles, including patient safety, anatomy, instrumentation, and the fundamentals of operating in a laparoscopic environment. The skills component is a hands-on assessment that evaluates core technical abilities, such as peg transfer, precision cutting, ligating loop, suturing with intracorporeal knot tying, and extraracorporeal knot tying. The FLS program aims to provide a structured curriculum for training in laparoscopic skills, standardize proficiency among practitioners, and enhance patient safety by ensuring surgeons are equipped with the necessary skills for laparoscopic procedures. Passing the FLS exam is often required for surgical residents before graduation and may also be necessary for board certification.

The objective of the training protocol is for all trainees to practice sufficiently to demonstrate proficiency in all five tasks. Training is designed to be self-directed, with heavy reliance on FLS video tutorials, although additional feedback may be provided when necessary. Trainee performance should be monitored regularly, and progress can be tracked using a training scoresheet or a custom spreadsheet. The use of FLS-approved training materials, such as double-circle gauze for precision cutting and reusable ligating loops, is required to maintain consistency.

Each of the five tasks has specific proficiency benchmarks. For the Peg Transfer task, trainees must complete the task in 48 seconds without dropping objects outside the field of view, achieving this level of performance on two consecutive and then 10 nonconsecutive repetitions. The Precision Cutting task requires all cuts to be made within designated lines in 98 seconds, while the Ligating Loop task must be completed in 53 seconds with up to 1 mm of accuracy error. Both of these tasks should also be mastered within two consecutive successful attempts, or a maximum of 80 repetitions.

The final two tasks, Suture with Extracorporeal Knot and Suture with Intracorporeal Knot, have more complex performance criteria. The Extracorporeal Knot task must be completed in 136 seconds with up to 1 mm accuracy errors, and the Intracorporeal Knot task must be performed in 112 seconds, meeting the same error standard. For reinforcement, the Intracorporeal Knot task must also be performed successfully on two consecutive repetitions and 10 additional nonconsecutive repetitions. If a trainee does not reach these standards within 80 attempts, they should move on to the next task.

The first task, Peg Transfer, requires candidates to use two Maryland dissectors to transfer six rubber ring objects across a pegboard. The objects are initially aligned on the side corresponding to the non-dominant hand. The task involves picking up each object mid-air with the non-dominant hand, transferring it to the dominant hand, and placing it on a peg on the opposite side. Once all six objects are transferred, the process is reversed. Precision is crucial, and penalties are assessed for dropping objects outside the field of view. If an object is dropped within the field and can be retrieved, the candidate may continue. However, using the drop as a transfer point is not permitted. Timing starts when the first object is touched and ends when the last object is released.

The second task, Precision Cutting, requires candidates to cut a marked circle from a two-ply piece of gauze using a Maryland dissector and endoscopic scissors. The gauze is clipped taut using a jumbo clip and secured with alligator clips, ensuring it remains suspended and stable during the procedure. The top layer of the gauze, marked with a circle, is the focus, and any deviation from the circle's outline results in penalties. The task demands that the initial cut begins at the edge of the gauze, and participants may switch hands with the instruments if needed. If the gauze comes loose during the task, it cannot be reaffixed, and the candidate must continue as best as possible. Timing begins when the gauze is first touched and ends when the circle is completely cut out.

The third task, Ligating Loop, simulates the placement of a ligating loop around a foam organ's appendage. Candidates use a grasper (either a Maryland dissector or a locking/ratcheted grasper) and a pre-tied ligating loop to secure the loop around a marked spot on the foam appendage. The loop must be positioned correctly, and the knot must be tightened securely without deviating from the mark. Once the loop is in place, candidates use a plastic pusher to slide the knot into position and cut the excess loop material. Errors include knot misplacement or failure to secure the loop properly. Timing for this task starts when the instruments or loop material are first visible on the monitor and ends when the loop is cut inside the trainer.

The fourth task, Suture with Extracorporeal Knot, requires suturing a penrose drain to close a slit using a long suture. Candidates use two needle drivers (or one needle driver and one Maryland dissector) to place the suture through two marked targets on the drain. They then tie three single knot throws outside the body and push them into place using a knot pusher, ensuring the slit in the drain is fully closed. The suture must be handled by the thread, not the needle, when introduced into the trainer. Proper tension must be applied to secure the knots, and the ends of the suture must be cut within the trainer. Penalties are given for knot slippage, deviation from the marked targets, or failure to close the slit. If the penrose drain is avulsed from the suture block, it results in automatic failure. Timing starts when the first instrument appears on the monitor and ends when both suture ends are cut.

The fifth task, Suture with Intracorporeal Knot, focuses on knot tying within the body. Using two needle drivers, candidates must place a short suture through the penrose drain at the marked points and tie three knots. The first knot must be a surgeon's knot (a double throw), followed by two single throws, with hand exchanges between each throw to ensure proper technique. As with the previous task, the suture must be handled by the thread when introduced. The knots must be tied securely to close the slit in the drain without slipping or coming apart. Penalties are assessed for improper suture placement, failure to close the slit, or knot insecurity. Timing begins when the first instrument is visible on the monitor and ends when both suture ends are cut. Automatic failure occurs if the penrose drain is separated from the suture block.

Overall, these tasks are integral to the FLS exam, which seeks to standardize laparoscopic skill assessment. Each task is demonstrated in Module Five of the FLS didactic curriculum, and participants are encouraged to familiarize themselves with the video tutorials for guidance. The emphasis on precision, timing, and adherence to procedure reflects the real-world demands of laparoscopic surgery, where efficiency and accuracy are paramount.

“Learning Fundamentals of Laparoscopic Surgery Manual Skills: An Institutional Experience With Remote Coaching and Assessment” (Shana Miles, Nicole Donnellan, Learning Fundamentals of Laparoscopic Surgery Manual Skills: An Institutional Experience With Remote Coaching and Assessment, Military Medicine, Volume 187, Issue 11-12, November-December 2022, Pages e1281-e1285, https://doi.org/10.1093/milmed/usab170), which is hereby incorporated by reference in its entirety, explored the effectiveness of live remote coaching in preparing obstetrics and gynecology residents for the Fundamentals of Laparoscopic Surgery (FLS) exam. The pilot study included ten third-year residents, with nine of them participating in remote live coaching sessions with minimally invasive gynecologic surgery (MIGS) fellows. Residents received an average of two live coaching sessions until both the learner and coach agreed on their readiness for the exam. The study found that participants significantly improved their performance, with average FLS assessment scores increasing from 8.8 to 11.3 out of 12 (P<0.03). Additionally, all learners successfully passed the manual skills portion of the FLS exam on their first attempt, demonstrating the efficacy of the remote training model. The findings suggest that live remote coaching can be a practical and effective alternative to traditional in-person instruction, offering flexibility while maintaining high standards of surgical education.

The study “Use of Collapsible Box Trainer as a Module for Resident Education” (Caban A M, Guido C, Silver M, Rossidis G, Sarosi G, Ben-David K. Use of collapsible box trainer as a module for resident education. JSLS. 2013 July-September; 17(3): 440-4. doi: 10.4293/108680813X13693422521430. PMID: 24018083; PMCID: PMC3771765), which is hereby incorporated by reference in its entirety, evaluated whether Train Anywhere Skill Kit (TASKit) provided by Ethicon Endo-Surgery Cincinnati, OH, USA could effectively improve fundamental laparoscopic skills (FLS) in first- and second-year general surgery residents compared to traditional simulation center training. Twenty residents were randomly assigned to either TASKit training or scheduled sessions at a simulation lab. Over six months, both groups were assessed on FLS tasks like peg transfer, pattern cutting, Endoloop application, and intracorporeal and extracorporeal knot tying. Results indicated that the TASKit group demonstrated significant improvements in efficiency, particularly in peg transfer, pattern cutting, Endoloop placement, and intracorporeal knot tying compared to their initial evaluations. The portable trainer's accessibility likely facilitated more frequent and convenient practice, contributing to the observed performance gains. Although both groups showed progress, the TASKit group generally performed tasks more quickly during final assessments. The study did not find significant differences in penalty scores between groups, suggesting that while task efficiency improved, error rates remained similar.

“The Impact of Video Games on Training Surgeons in the 21st Century” (Rosser J C, Lynch P J, Cuddihy L, Gentile D A, Klonsky J, Merrell R. The Impact of Video Games on Training Surgeons in the 21st Century. Arch Surg. 2007; 142(2):181-186. doi:10.1001/archsurg.142.2.181), which is hereby incorporated by reference in its entirety, examined the impact of video game experience on the laparoscopic skills of surgeons, suggesting a significant correlation between video gaming and surgical proficiency. The study involved surgical residents and attending physicians who participated in laparoscopic skill drills and video game exercises, finding that those with extensive video game experience performed faster and made fewer errors in surgical tasks. Specifically, past and current video game players showed improved hand-eye coordination, reaction time, and spatial awareness, leading to better overall performance.

### SUMMARY OF THE INVENTION

The invention is a modular and ergonomically designed training device, that assists in the teaching and assessment of surgical procedures, particularly laparoscopic techniques. It features a combination of physical hardware and software components that provide real-time feedback and guidance using Augmented Reality (AR) and artificial intelligence (AI) technologies.

Specifically, the system overcomes the limitations of conventional systems like TASKit. For example, these conventional systems require an in-person proctor to coach each task to ensure they are learning correctly, do not provide real-time scoring, and do not include ipsilateral ports. Accordingly, embodiments of the invention represent a significant advancement in surgical training technology, combining physical and digital elements to create an engaging and effective learning platform.

Aspects of the invention include integrating a light source, a pegboard attachment structure, and height adjustment mechanisms enhancing the realism and flexibility of the training environment, making it adaptable to various surgical scenarios and user needs. Additionally, the use of augmented reality (AR) and artificial intelligence (AI) minimizes the necessity for live instruction, providing a scalable and efficient training solution that can be implemented widely. Its compatibility with most tablets further increases its accessibility and ease of use, facilitating simple adoption across different training settings.

Aspects of the invention include numerous advantages for surgical skill development. By combining tactile feedback with digital coaching, it fosters an engaging and effective learning experience. Ergonomically designed features ensure user comfort and promote proper posture, which is essential for prolonged training sessions. Furthermore, real-time feedback and automated assessment increase efficacy of the learning process, enabling trainees to identify and correct mistakes on the spot, ultimately accelerating skill acquisition and mastery.

### BRIEF DESCRIPTION OF THE DRAWINGS

FIG. 1A is a first view of a representation of a modular structural frame that is fully assembled in accordance with embodiments of the invention.

FIG. 1B is a second view of a representation of a modular structural frame that is fully assembled in accordance with embodiments of the invention.

FIG. 1C is a third view of a representation of a modular structural frame that is fully assembled in accordance with embodiments of the invention.

FIG. 2 is a representation of the modular structural frame that is in a first stage of collapse in accordance with embodiments of the invention.

FIG. 3 is a representation of the modular structural frame that is in a second stage of collapse in accordance with embodiments of the invention.

FIG. 4 is a representation of the modular structural frame that is in a third stage of collapse in accordance with embodiments of the invention.

FIG. 5 is a representation of the modular structural frame that is fully collapsed in accordance with embodiments of the invention.

FIG. 6A is a schematic representation of a first view of the modular structural frame that is fully assembled in accordance with embodiments of the invention.

FIG. 6B is a schematic representation of a second view of the modular structural frame that is fully assembled in accordance with embodiments of the invention.

FIG. 7A illustrates an example user interface for an AR environment for training for the Peg Transfer task.

FIG. 7B illustrates an example user interface for an AR environment for training for the Peg Transfer task.

FIG. 7C illustrates an example user interface for an AR environment for training for the Peg Transfer task.

FIG. 7D illustrates an example user interface for an AR environment for training for the Peg Transfer task.

FIG. 7E illustrates an example user interface for an AR environment for training for the Peg Transfer task.

FIG. 7F illustrates an example user interface for an AR environment for training for the Peg Transfer task.

FIG. 8A illustrates an example user interface for an AR environment for training for the precision cutting task.

FIG. 8B illustrates an example user interface for an AR environment for training for the precision cutting task.

FIG. 8C illustrates an example user interface for an AR environment for training for the precision cutting task.

FIG. 8D illustrates an example user interface for an AR environment for training for the precision cutting task.

FIG. 8E illustrates an example user interface for an AR environment for training for the precision cutting task.

FIG. 8F illustrates an example user interface for an AR environment for training for the precision cutting task.

FIG. 8G illustrates an example user interface for an AR environment for training for the precision cutting task.

FIG. 9A illustrates an example user interface for an AR environment for training for the ligating loop task.

FIG. 9B illustrates an example user interface for an AR environment for training for the ligating loop task.

FIG. 9C illustrates an example user interface for an AR environment for training for the ligating loop task.

FIG. 9D illustrates an example user interface for an AR environment for training for the ligating loop task.

FIG. 9E illustrates an example user interface for an AR environment for training for the ligating loop task.

FIG. 9F illustrates an example user interface for an AR environment for training for the ligating loop task.

FIG. 9G illustrates an example user interface for an AR environment for training for the ligating loop task.

FIG. 10A illustrates an example user interface for an AR environment for training for the simple suture intracorporeal knot task.

FIG. 10B illustrates an example user interface for an AR environment for training for the simple suture intracorporeal knot task.

FIG. 10C illustrates an example user interface for an AR environment for training for the simple suture intracorporeal knot task.

FIG. 10D illustrates an example user interface for an AR environment for training for the simple suture intracorporeal knot task.

FIG. 10E illustrates an example user interface for an AR environment for training for the simple suture intracorporeal knot task.

FIG. 10F illustrates an example user interface for an AR environment for training for the simple suture intracorporeal knot task.

FIG. 10G illustrates an example user interface for an AR environment for training for the simple suture intracorporeal knot task.

FIG. 10H illustrates an example user interface for an AR environment for training for the simple suture intracorporeal knot task.

FIG. 11A illustrates an example user interface for an AR environment for training for the simple suture extracorporeal knot task.

FIG. 11B illustrates an example user interface for an AR environment for training for the simple suture extracorporeal knot task.

FIG. 11C illustrates an example user interface for an AR environment for training for the simple suture extracorporeal knot task.

FIG. 11D illustrates an example user interface for an AR environment for training for the simple suture extracorporeal knot task.

FIG. 11E illustrates an example user interface for an AR environment for training for the simple suture extracorporeal knot task.

FIG. 11F illustrates an example user interface for an AR environment for training for the simple suture extracorporeal knot task.

FIG. 11G illustrates an example user interface for an AR environment for training for the simple suture extracorporeal knot task.

FIG. 11H illustrates an example user interface for an AR environment for training for the simple suture extracorporeal knot task.

FIG. 11A illustrates an example user interface for an AR environment for training for the simple suture extracorporeal knot task.

FIG. 12A illustrates an example user interface for an AR environment for training for the STRATAFIX™ Symmetric PDS™ Plus incision closure STRATAFIX™ Symmetric PDS™ Plus incision closure task.

FIG. 12B illustrates an example user interface for an AR environment for training for the STRATAFIX™ Symmetric PDS™ Plus incision closure STRATAFIX™ Symmetric PDS™ Plus incision closure task.

FIG. 12C illustrates an example user interface for an AR environment for training for the STRATAFIX™ Symmetric PDS™ Plus incision closure STRATAFIX™ Symmetric PDS™ Plus incision closure task.

FIG. 12D illustrates an example user interface for an AR environment for training for the STRATAFIX™ Symmetric PDS™ Plus incision closure STRATAFIX™ Symmetric PDS™ Plus incision closure task.

FIG. 12E illustrates an example user interface for an AR environment for training for the STRATAFIX™ Symmetric PDS™ Plus incision closure STRATAFIX™ Symmetric PDS™ Plus incision closure task.

FIG. 12F illustrates an example user interface for an AR environment for training for the STRATAFIX™ Symmetric PDS™ Plus incision closure STRATAFIX™ Symmetric PDS™ Plus incision closure task.

FIG. 12G illustrates an example user interface for an AR environment for training for the STRATAFIX™ Symmetric PDS™ Plus incision closure STRATAFIX™ Symmetric PDS™ Plus incision closure task.

FIG. 12H illustrates an example user interface for an AR environment for training for the STRATAFIX™ Symmetric PDS™ Plus incision closure STRATAFIX™ Symmetric PDS™ Plus incision closure task.

### DETAILED DESCRIPTION OF THE PREFERRED EMBODIMENTS

The modular structural frame described hereinafter presents an innovative approach to training for minimally invasive surgical procedures. Designed to simulate the confined and ergonomically challenging environment of laparoscopic surgery, the frame features a pegboard base for attaching various training modules and strategically placed trocar ports that mirror real-world instrument insertion scenarios. In addition, certain embodiments include adjustable height and port angles, and the frame accommodates users of different statures, ensuring optimal posture and comfort while replicating the spatial constraints faced in an operating room setting. Additionally, a built-in, rechargeable light source enhances visibility, providing illumination akin to that in a clinical environment.

The integration of technology further elevates the training experience, with an adjustable platform to mount a tablet that serves as a conduit for augmented reality (AR) and artificial intelligence (AI) functionalities. The AR software overlays step-by-step guidance and visual cues on the live video feed captured by the tablet's camera, enabling users to practice surgical techniques such as object manipulation, precision cutting, and knot tying. Meanwhile, AI-driven analysis continuously assesses the trainee's performance, delivering personalized feedback and categorizing proficiency levels to guide skill development. This holistic, technology-driven setup ensures a realistic, adaptive, and effective training platform, suitable for preparing surgical residents to master critical skills and meet the demands of high-stakes surgical assessments.

For example, embodiments of the invention include a modular structural frame that forms a partially enclosed volume, simulating a realistic surgical environment. The base of the frame features a pegboard structure that allows for the attachment of various training modules, enhancing the flexibility and adaptability of the device. The perimeter of the frame is equipped with ergonomically positioned trocar ports, designed for ipsilateral tool use to mirror clinical scenarios accurately. In some instances, these ports are adjustable, allowing the angles of tool insertion to be customized for optimal ergonomics. In some instances, the frame itself can be adjusted in height to accommodate users of different statures, ensuring comfort and proper posture during training.

A rechargeable light source is integrated into the frame, providing necessary illumination for the enclosed space, which is critical for performing surgical simulations. Positioned at the top of the frame is an adjustable platform designed to securely hold a tablet computer, such as an iPad. The device includes a dedicated port that aligns the tablet's camera, enabling it to capture real-time video images of the simulated surgical area. These hardware features work together to create a versatile and realistic training setup.

Aspects of the invention can be implemented in software that utilizes AR and AI to guide and assess the user's performance. Using the tablet's camera, the system captures video footage of the user's surgical maneuvers. The AR technology overlays graphics and instructional text on the video display, providing step-by-step guidance for performing various tasks, such as manipulating objects, cutting tissue, ligating, knot tying, and suturing. AI algorithms continuously analyze the captured footage, assessing the quality of the user's technique and offering real-time feedback. In addition, in some instances, the system can score the user's performance, categorizing them as beginner, intermediate, or expert, based on how well they execute the tasks. In some instances, the scoring includes calculating a tool path distance that the surgical implements traveled and comparing that distance to a known standard.

In some instances, the ML/AI trained with data labeled by expert surgeons. For example, an expert surgeon may view a recording of the student performing the various task and score the student. The expert surgeon's scoring is then used a labeled data to train the ML/AI.

In some embodiments, the system stores user progress in a public or private cloud. This feature allows trainees and program directors to track performance over time and identify areas for improvement. The automated, AI-driven feedback reduces the need for in-person proctors, making the training process more scalable and efficient. Additionally, embodiments are compatible with most tablets, which facilitates easy adoption and integration into various training environments.

AR is an advanced technology that integrates digital elements into the real world, allowing users to experience an enhanced version of their physical environment. Unlike Virtual Reality (VR), which completely immerses a person in a simulated digital world, AR seamlessly overlays computer-generated content—such as images, sounds, and interactive features—onto the real world in real time. This blending of digital and physical elements creates a more interactive and enriched user experience.

AR typically operates through devices like smartphones, tablets, or specialized AR glasses. These devices are equipped with cameras, sensors, and computer vision technology to detect and map the physical surroundings. By analyzing this data, AR software can place digital content accurately within the user's environment, making it appear as if virtual objects are part of the real world. For instance, in the popular AR game Pokémon GO, players see animated characters overlaid on real-world settings through their smartphone cameras, creating an engaging experience that combines virtual creatures with physical locations.

Beyond gaming, AR has a wide range of practical applications across various fields. In navigation, AR can provide real-time, overlaid directions on streets or buildings, helping users find their way more intuitively. In education, AR brings subjects to life by allowing students to explore complex concepts interactively; for example, they can view and manipulate a 3D model of the human body or historical landmarks as if these were right in front of them. Retailers also use AR to transform shopping experiences—consumers can virtually try on clothing and makeup or see how furniture would look in their homes before making a purchase. Additionally, AR is making a significant impact in industrial training and maintenance, where digital overlays can guide workers through complex procedures, such as showing step-by-step instructions on how to operate or repair machinery, thereby improving efficiency and accuracy.

The technical implementation of AR is a complex integration of hardware and software components, working together to blend virtual content with the real world in a seamless and interactive manner. The hardware layer consists of essential components such as cameras, sensors, processors, and display units. Cameras and sensors, including accelerometers, gyroscopes, and/or GPS, play a crucial role in capturing information about the physical environment. Cameras provide continuous visual data, while sensors track the device's orientation and movement, allowing AR applications to understand the user's perspective and adjust the virtual content accordingly. Modern AR systems rely on powerful processing units, including both central processing units (CPUs) and graphics processing units (GPUs), to perform the necessary real-time computations. These processors handle tasks like image analysis, environment mapping, and rendering virtual objects, all of which require significant computational power.

On the software side, AR relies heavily on computer vision algorithms to interpret and make sense of the physical world. Using sophisticated image recognition techniques, the software identifies and tracks features in the environment, such as edges, surfaces, and objects. A key component in this process is Simultaneous Localization and Mapping (SLAM), which enables the system to track the device's position while constructing a dynamic map of the surroundings. SLAM is fundamental for maintaining the spatial stability of virtual objects as the user moves, ensuring that the augmented content appears anchored to real-world locations. Additionally, some AR systems incorporate depth sensing, either through specialized depth cameras or algorithms that calculate depth from images, to determine the distance between objects and the device. This depth information helps the system understand spatial relationships and enhances the realism of virtual content by properly positioning and scaling objects in the 3D environment.

The rendering engine is another critical component that generates and overlays virtual content. It uses 3D graphics techniques and real-time rendering to create visually accurate and responsive digital objects. The rendering engine must consider various factors, such as lighting and shadows, to ensure that virtual elements blend naturally with the real environment. By simulating lighting conditions and generating realistic shadows, the AR system enhances the believability of the augmented experience. Motion tracking is achieved through a combination of sensor data and computer vision, allowing the system to monitor the device's orientation and movement with high precision. This tracking ensures that virtual content stays properly aligned with the real world, even as the user changes their position or angle.

Advanced AR systems also include capabilities for environment understanding, where the software detects and analyzes flat surfaces like floors and walls or even recognizes specific objects. This enables more interactive and context-aware experiences, where virtual content can interact realistically with physical elements. For example, a virtual character might walk along a real table or a digital object might hide behind a physical one. User interaction with AR content is facilitated through various input methods, such as gesture recognition, voice commands, or touch input. Gesture recognition involves tracking hand movements or finger gestures using computer vision, while voice commands are processed through natural language processing (NLP) to control or interact with virtual elements. On smartphones and tablets, users often manipulate AR content using touch gestures, such as dragging or rotating objects on the screen.

In some cases, AR systems leverage cloud computing to enhance functionality. Cloud-based AR allows for offloading computationally intensive tasks, such as complex image recognition or data storage, to remote servers. This can enable more sophisticated experiences, such as recognizing objects from a large database or synchronizing virtual content across multiple users and devices. Network connectivity is also crucial for multi-user AR experiences, where real-time data synchronization ensures that all participants see and interact with the same augmented content. The integration of all these components—hardware, computer vision, environment mapping, real-time rendering, and user interface mechanisms—creates the foundation of AR technology, enabling a seamless blend of the digital and physical worlds.

Overlays in an AR system are created through a sophisticated process that integrates real-time scene analysis, 3D rendering, and precise tracking of the physical environment. The system begins by capturing and interpreting the real world using the device's camera and sensors. Computer vision algorithms identify key features like edges, textures, and surfaces, while techniques such as Simultaneous Localization and Mapping (SLAM) track the device's movement and build a dynamic map of the surroundings.

SLAM is a computational technique used in robotics and AR to simultaneously build a map of an unknown environment and keep track of the device's location within that map. Essentially, SLAM addresses the challenge of understanding and navigating an environment without prior knowledge or reference data. It is critical for applications that require real-time tracking and mapping, such as self-driving cars, autonomous drones, and AR systems, where it enables virtual content to be accurately placed and remain stable as the user or device moves around.

The SLAM process involves a few key steps. First, the device's sensors—typically cameras, depth sensors, and motion sensors like accelerometers and gyroscopes—gather data about the surrounding environment. Computer vision algorithms analyze this data to identify distinct features in the scene, such as corners, edges, or recognizable patterns. The system then uses these features as landmarks to construct a map while simultaneously calculating the device's position and orientation relative to those landmarks. As the device moves, SLAM updates both the map and the device's location by continuously detecting new features and matching them with existing ones. This feedback loop allows the system to refine its understanding of the environment, correct for errors in localization, and maintain accurate spatial mapping, even in dynamic or changing environments.

While SLAM is a popular method for real-time tracking and mapping, several alternatives exist that cater to different applications and requirements. One such alternative is Structure from Motion (SfM), a computer vision technique used to reconstruct 3D structures from a series of 2D images taken from various angles. Unlike SLAM, which operates in real time, SfM typically works offline and is widely used in fields like photogrammetry and 3D modeling. Another method is Visual Odometry (VO), which estimates a device's movement by analyzing changes between consecutive camera frames. VO is often used for real-time motion tracking in robotics and autonomous vehicles but does not build a persistent map of the environment like SLAM does.

Graph-based mapping represents the environment as a graph, with nodes corresponding to positions and edges representing spatial relationships. Optimization algorithms, such as GraphSLAM, refine the map and correct localization errors, making it suitable for applications where offline optimization is acceptable. Extended Kalman Filter (EKF) Localization uses probabilistic models to estimate a system's state, incorporating data from sensors to update the position and velocity estimates. EKF is effective in environments where additional sensor data is available. Similarly, Monte Carlo Localization (MCL), or Particle Filter Localization, uses particles to represent possible positions, updating their probabilities based on sensor observations to converge on the most likely location. This method is often used in mobile robotics for indoor navigation. Each alternative presents a unique set of trade-offs in terms of real-time performance, computational complexity, and environmental suitability.

The rendering engine then generates 3D models, animations, images, or text that will be overlaid onto the real-world scene. To achieve realism, the system applies graphics techniques such as texture mapping, shading, and dynamic lighting, which adjust to the physical environment's conditions. Depth sensing or depth-mapping algorithms determine how virtual content should interact with real-world objects, managing occlusion to ensure natural integration—like making a virtual object appear behind a real one when appropriate. Finally, compositing techniques blend the digital content with the live camera feed, and post-processing effects, such as shadows and lighting adjustments, further enhance the illusion that the virtual elements are seamlessly embedded in the physical world.

Depth-mapping algorithms are essential in AR for accurately positioning virtual content relative to real-world objects and handling spatial interactions, such as occlusions. Several algorithms are commonly used to achieve this. Stereo Vision utilizes two cameras placed at a known distance apart to mimic human binocular vision. By analyzing the disparity between images from the two cameras, the algorithm calculates depth and constructs a 3D map of the environment, making it suitable for mobile AR systems with dual-camera setups. Structured Light involves projecting a known pattern onto the environment and analyzing how it deforms when it hits surfaces. By measuring these distortions, the algorithm generates a depth map, commonly used in facial recognition systems and AR devices with 3D sensors. Another widely used approach is Time-of-Flight (ToF), where sensors emit light pulses and measure the time it takes for the light to return from objects. The time delay, combined with the speed of light, provides accurate distance measurements, making ToF ideal for applications needing real-time depth data, such as AR games and measuring tools.

Depth from Defocus (DfD) estimates depth by analyzing the blur in images. By comparing image sharpness or using sequences captured with different focus settings, the algorithm determines relative depth, providing precise information without requiring additional hardware. In contrast, Monocular Depth Estimation infers depth from a single camera image using computer vision or machine learning models trained on extensive datasets. These models recognize depth cues like object size and shading, allowing AR applications on smartphones without dedicated depth sensors to approximate depth in real time. Optical Flow algorithms estimate depth by analyzing how objects or surfaces move in a sequence of images. By understanding relative motion, the algorithm deduces the distance of objects, useful for tracking and depth estimation in dynamic AR environments. Finally, LiDAR-Based Depth Mapping uses laser pulses to measure distances with high precision. LiDAR sensors emit laser beams that reflect off surfaces, and the return time is used to create detailed 3D maps. This method is employed in advanced AR features and high-end devices, such as the iPad Pro and iPhone Pro models, where accuracy and real-time performance are crucial. Each algorithm has its strengths and is chosen based on factors like hardware availability, desired depth accuracy, and specific AR use cases.

AI is a broad discipline within computer science dedicated to developing systems that can perform tasks typically requiring human intelligence. These tasks range from perception, such as understanding speech and recognizing images, to reasoning and decision-making in complex scenarios. AI systems are designed to mimic cognitive functions like learning, problem-solving, and adapting to new information. The field encompasses a wide variety of methodologies, including knowledge-based systems, deep neural networks, and natural language processing, each tailored to replicate specific human-like abilities.

ML is a crucial subset of AI that focuses on creating algorithms capable of identifying patterns and making decisions based on data. Instead of being explicitly programmed for each specific task, ML models are built to learn from and improve through exposure to data. Supervised learning involves training a model on labeled data, where the correct outcomes are provided, while unsupervised learning works with unlabeled data to discover hidden patterns. Reinforcement learning, another key area, allows models to learn optimal actions through trial and error, receiving feedback in the form of rewards or penalties.

Labeling is the process of assigning meaningful annotations or tags to data, which is crucial in supervised machine learning. It involves providing additional information about each data point so that a model can learn to make predictions or classifications based on that information. Labeling ensures that the model understands what the input data represents and what the desired output should be.

For instance, in a classification problem, labeling involves associating each data sample with a specific category or class. In an image classification task, labeling might mean marking an image of a cat with the label “cat” and an image of a dog with the label “dog.” Similarly, in natural language processing (NLP) tasks, labeling could involve tagging words in a sentence with their respective parts of speech or identifying named entities like names of people or organizations.

In practice, labeling can be a time-consuming and resource-intensive process, especially for large datasets. It often requires domain expertise to ensure the labels are accurate and meaningful. To automate or simplify this process, methods like crowdsourcing (e.g., using platforms like Amazon Mechanical Turk) or semi-supervised learning (where a small amount of labeled data is combined with a large amount of unlabeled data) are sometimes employed. The quality and consistency of labels are critical because the performance of a machine learning model is directly dependent on the quality of the labeled training data.

Reinforcement Learning (RL) is implemented through a framework where an agent learns to make decisions by interacting with an environment to achieve a specific goal. The core idea is to train the agent to maximize cumulative rewards over time by learning which actions to take in various situations. The RL process is characterized by trial and error, with the agent continuously improving its strategy based on feedback received from the environment.

The implementation of RL involves several key components: the agent, the environment, states, actions, and rewards. The agent observes the state of the environment and selects an action based on a policy, which is the strategy for decision-making. After executing an action, the agent receives a reward, which is a numerical signal that indicates how good or bad the action was in achieving the goal. The environment transitions to a new state, and the agent uses this feedback to update its policy. The agent aims to find an optimal policy that maximizes the expected cumulative reward, often using algorithms like Q-learning or policy gradient methods.

To achieve efficient learning, RL often employs techniques such as Q-learning, which uses a value-based approach to estimate the expected utility of taking a specific action in a given state. The Q-value is updated iteratively using the Bellman equation. Alternatively, Deep Q-Networks (DQN) combine Q-learning with deep learning to handle high-dimensional state spaces by approximating the Q-value function using a neural network. Policy gradient methods are another approach, where the policy is represented directly as a neural network, and gradients are computed to optimize the policy's parameters. Advanced methods like Actor-Critic algorithms combine value-based and policy-based approaches, using two models: an actor that decides the actions and a critic that evaluates how good the actions are. This combination helps stabilize and speed up the learning process.

Backpropagation is a fundamental algorithm used in training artificial neural networks, specifically for optimizing the weights of the network to minimize the error between the predicted output and the actual output. It is a supervised learning technique that calculates the gradient of the loss function with respect to each weight in the network, enabling efficient weight updates using optimization algorithms like gradient descent.

The process of backpropagation consists of two main phases: the forward pass and the backward pass. During the forward pass, the input data is passed through the network layer by layer, and the output is computed using the current weights. The loss function, which measures the difference between the network's predicted output and the true target value, is then calculated. Common loss functions include mean squared error for regression tasks and cross-entropy loss for classification problems.

In the backward pass, the algorithm computes the gradient of the loss function with respect to each weight in the network using the chain rule of calculus. This involves propagating the error backward through the network from the output layer to the input layer, adjusting the weights layer by layer. The gradients indicate the direction and magnitude of the change needed to minimize the error. By iteratively updating the weights in the direction that reduces the loss, the network learns to make better predictions. This optimization process continues until the model converges, achieving a minimal loss value or reaching a predefined number of iterations.

The power of ML lies in its use of statistical methods to optimize model performance as more data becomes available. Techniques such as gradient descent, backpropagation in neural networks, and Bayesian inference are integral to refining predictions and adapting to new datasets. Additionally, ML models can range in complexity from simple linear regression to sophisticated architectures like convolutional neural networks (CNNs) for image processing and recurrent neural networks (RNNs) for handling sequential data. By leveraging vast amounts of data and computational resources, ML has become the backbone of modern AI applications, enabling advancements in areas such as autonomous vehicles, predictive analytics, and personalized recommendations.

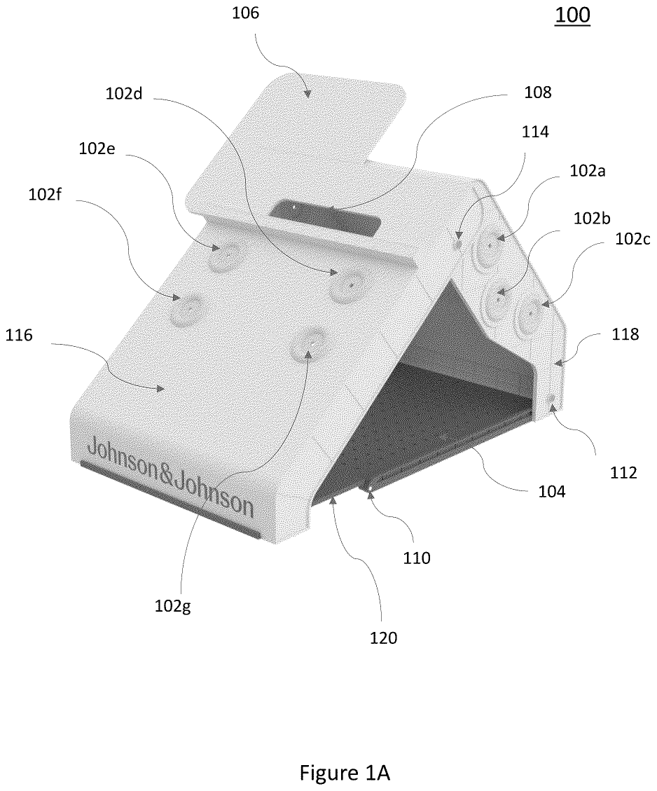

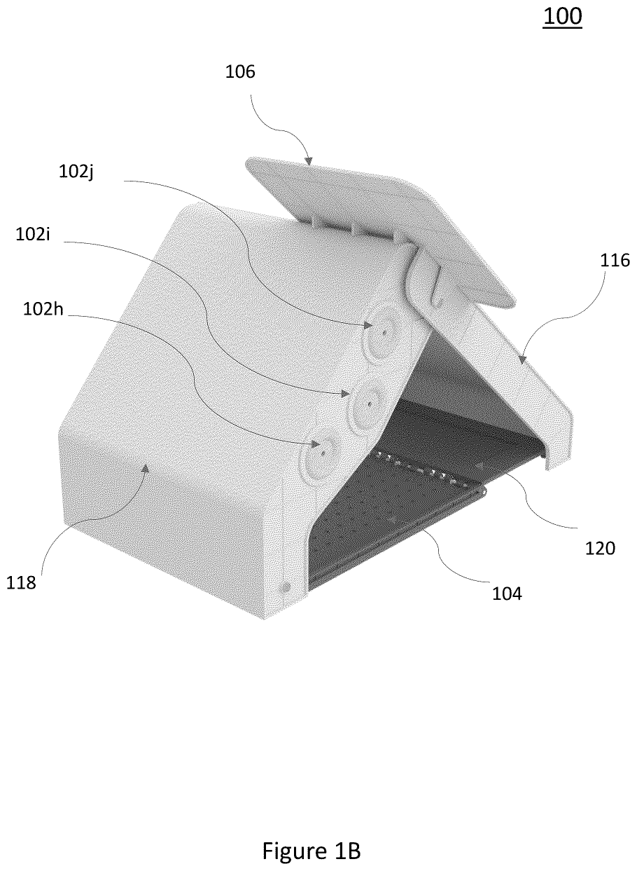

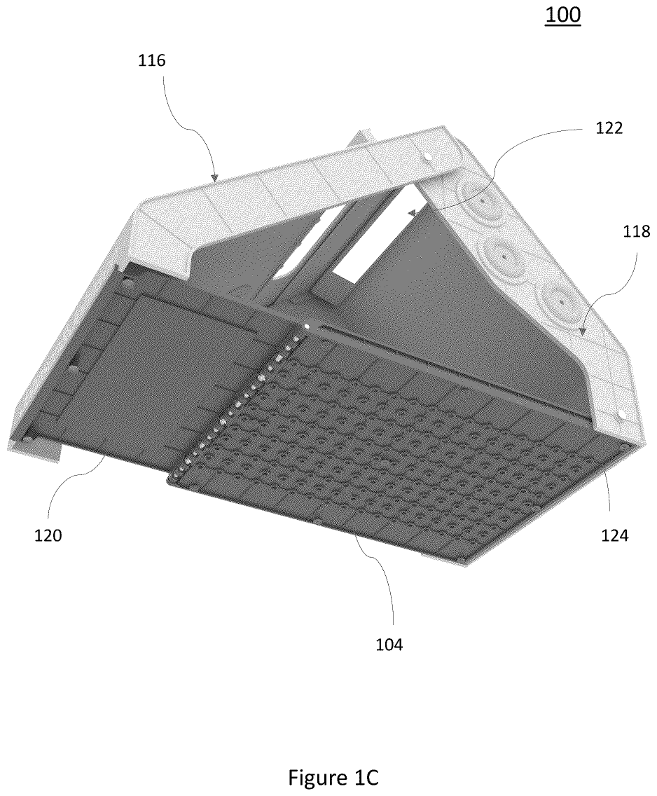

FIG. 1A illustrates a first view of an example of a modular structural frame 100 in accordance with an aspect of the invention. The modular structural frame 100 forms a partially enclosed volume, simulating the confined space encountered in minimally invasive surgeries. The modular structural frame 100 is constructed from durable, lightweight materials, ensuring portability and ease of assembly. Embodiments include one or more trocar ports 102a-102j. Trocar Ports are specialized openings or entry points designed for the insertion of trocars, which are surgical instruments used to create access points during minimally invasive procedures, such as laparoscopic surgery. In this training device, the trocar ports are integrated into the structural frame to allow realistic practice of instrument insertion and manipulation.

The trocar ports 102a-102j in embodiments of the invention are strategically positioned around the perimeter of the training device to replicate the placement and angles typically encountered during actual surgical procedures. In some instances, the location of the trocar ports 102a-102j are also adjustable to ensure ergonomic positioning, which is essential for realistic simulation and to accommodate users of different heights and body types. This adjustability allows the trainee to experience and practice proper hand positioning and movements required for performing surgical tasks, such as suturing or tissue manipulation, in a controlled and safe environment.

In some instances, the modular structural frame 100 includes trocar ports 102a-102c and/or 102h-102j that are positioned on the side of the device to replicate Ipsilateral ports. Ipsilateral ports refer to trocar ports that are positioned on the same side of the body as the hand being used to perform a surgical procedure. In the context of minimally invasive surgical training, ipsilateral port placement means that the ports are ergonomically aligned in a way that mimics the positioning surgeons would use when working on one side of a patient's body during an operation.

The inclusion of trocar ports 102a-102c and/or 102h-102j ensures that the training environment accurately replicates the physical and spatial challenges of real surgical procedures, allowing trainees to develop the muscle memory and coordination necessary for effective surgical performance. It also allows for the training of both left-handed and right-handed surgeons. By practicing with ipsilateral ports, users can gain familiarity with the instrument angles and movements required in actual surgeries, making the training experience more clinically relevant and effective.

The modular structural frame 100 also includes a peg board 104. The pegboard 104 is positioned at the base of the modular structural frame 100, serving as a versatile platform for attaching various training modules. This design enables the simulation of multiple surgical tasks, such as object manipulation, cutting, ligating, knot tying, and suturing.

The modular structural frame 100 further includes an adjustable platform 106. The adjustable platform 106 is mounted at the top of the frame to securely hold a tablet computer. A dedicated port 108 aligns the tablet's camera to capture video images of the internal training area. This setup facilitates the integration of digital guidance and feedback.

The modular structural frame 100 of the training device is designed to be collapsible, making it convenient for storage and transport. The frame likely features hinged joints or interlocking segments that allow it to fold or be disassembled easily. One possible design involves hinged sections that enable the sides and base to fold inward, collapsing the frame into a compact, flat form when the hinges are unlocked or disengaged. Alternatively, the frame could use interlocking components that can be detached and stacked, allowing for straightforward reassembly. Quick-release mechanisms, such as clamps or sliding locks, might be integrated into the ports and adjustable elements to facilitate rapid assembly and disassembly without the need for extra tools. This design ensures the training kit remains lightweight and portable, making it practical for use in diverse training environments, from classrooms to remote simulation settings.

For example, the modular structural frame 100 includes hinges 110, 112, and 114. Hinge 114 mechanically couples a front portion 116 of the modular structural frame 100 to a back portion 118 of the modular structural frame 100. Hinge 112 mechanically couples the back portion 118 to the peg board 104. Hinge 110 mechanically couples the peg board 104 to a flange 120. The flange 120 mechanically couples to the front portion 116. In some instances, the flange 120 mechanically couples to the front portion 116 via a flip or channel formed in the flange.

FIG. 1B is a second view of the modular structural frame 100 that shows the features on the left side of the modular structural frame 100 that were hidden in the first view of FIG. 1A. Specifically, FIG. 1B illustrates an embodiment where trocar ports 102h-102j are positioned as Ipsilateral ports on the left side. These ports may be particularly useful for left-handed surgeons.

FIG. 1C is a third view of the modular structural frame 100. Specifically, FIG. 1C illustrates the light source 122. The light source 122 is a rechargeable light source is integrated within the enclosed volume, providing adequate illumination to mimic the lighting conditions of an operating room. This feature enhances visibility and realism during training sessions.

In some instances, the color of the light and the brightness of the light source 122 may be controlled by the tablet. For example, light may go off in the middle of the training module to train the surgeon to respond to similar situations in an operating room. Or alternatively, the illumination may be dimmed or changed to a darker color to simulate working in a darker cavity within the patient. In further instances, the color may be changed to alert the surgeon of the remaining time in a module.

In some embodiments, the inner surface 124 of back part 118 is partially covered with a reflective surface such as a mirror. This reflective surface can be utilized to provide an additional angle of the partially enclosed volume while the surgeon is performing the modules. In some instances, this additional angle is utilized by the AI and AR systems without showing the additional angle to the surgeon. For example, the image of the reflective surface may be cropped from the image displayed to the surgeon. However, this additional angle may be utilized to score, evaluate, and monitor the performance of the surgeon. For instances, the surgeon may have properly tied a suture. However, the suture may have rotated so the first view of the camera cannot see the suture but the reflected image may be able to see the suture.

Accordingly, FIGS. 1A-1C illustrate the modular structural frame 100 that provides a comprehensive and realistic training environment for minimally invasive surgical procedures. Constructed from lightweight, durable materials, the frame simulates a confined space similar to what surgeons encounter in practice. It features multiple trocar ports, strategically placed and adjustable to replicate the ergonomic positioning necessary for effective surgical training. This design ensures that trainees can practice essential skills, such as instrument insertion, suturing, and tissue manipulation, in a controlled setting. Additionally, ipsilateral port placement mimics real-world scenarios, offering valuable practice opportunities for both left- and right-handed users.

Further enhancing the training experience, the modular structural frame includes a pegboard for versatile task simulation and an adjustable platform that holds a tablet for capturing video images and providing digital feedback. The collapsible design of the frame, with hinged and interlocking components, ensures easy assembly and portability, making it suitable for various training environments. In some instances, features like a rechargeable, controllable light source and a reflective surface provide realistic illumination and additional performance monitoring capabilities. The system may also incorporate advanced functionality, such as adjusting light conditions to simulate operating room scenarios and utilizing reflective surfaces to assess performance, even from hidden angles, ensuring a thorough and clinically relevant training experience.

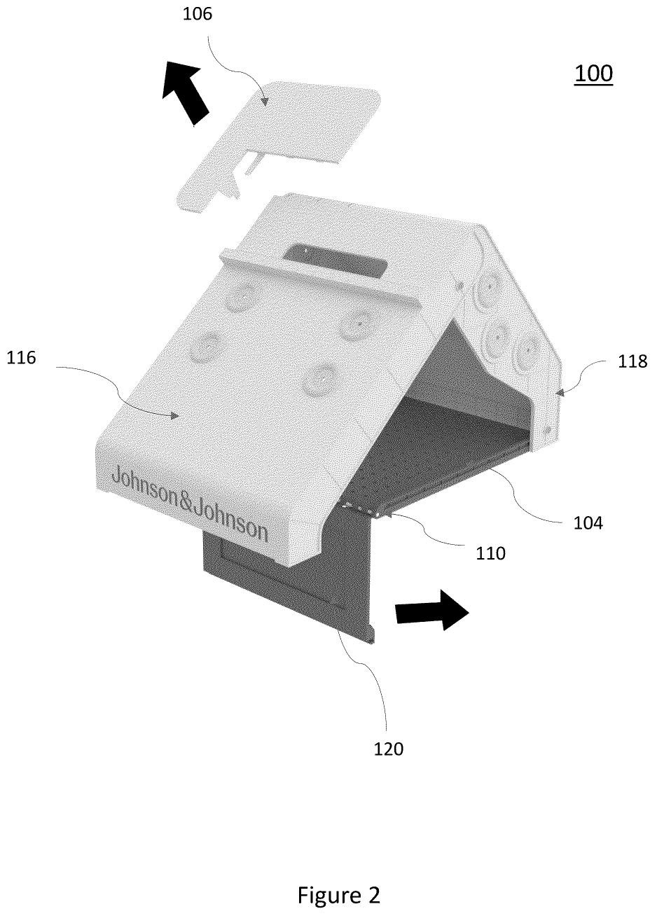

FIG. 2 illustrates the first stage in collapsing the modular structural frame 100. Specifically, FIG. 2 illustrates that the adjustable platform 106 is decoupled from the front portion 116. In addition, flange 120 has disengaged from the front portion 116 by pivoting about hinge 110 towards the peg board 104.

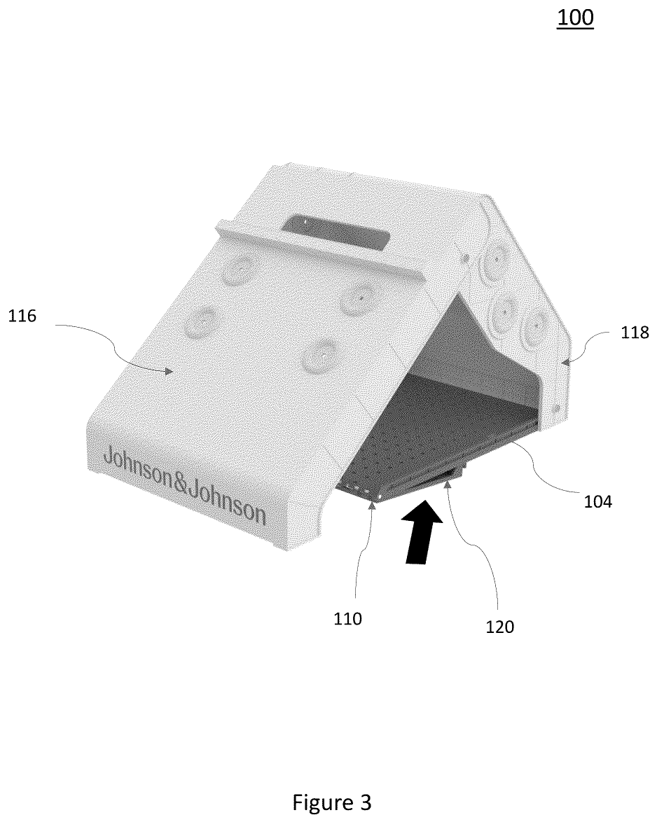

FIG. 3 illustrates a second stage in collapsing the modular structural frame 100. Specifically, FIG. 3 shows the flange 120 fully rotates towards the peg board 104. In some embodiments, the flange 120 mechanically couples to the peg board 104 and utilizes clips or grooves (not shown).

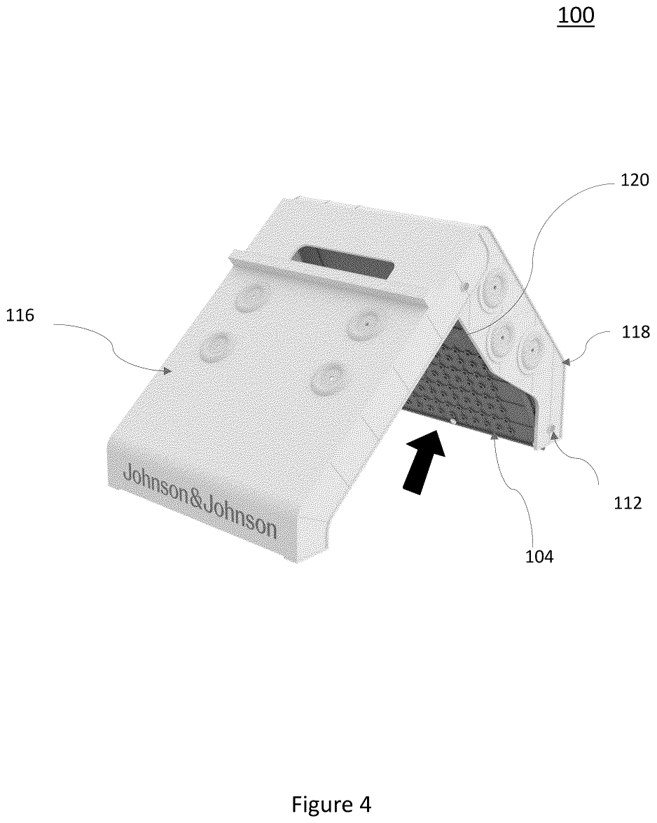

FIG. 4 illustrates a third stage in collapsing the modular structural frame 100. Specifically, FIG. 4 shows the peg board fully rotated about hinge 112 towards the back portion 118. In some instances, the peg board 104 mechanically couples to the back portion utilizing clips or grooves (not shown). Since the flange 120 is mechanically coupled to the peg board 104, the flange 120 also rotates about hinge 112.

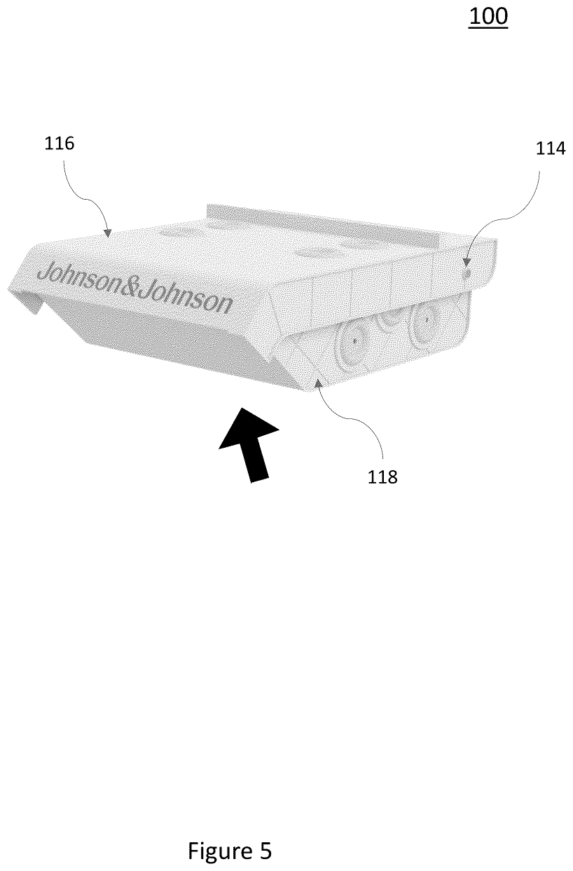

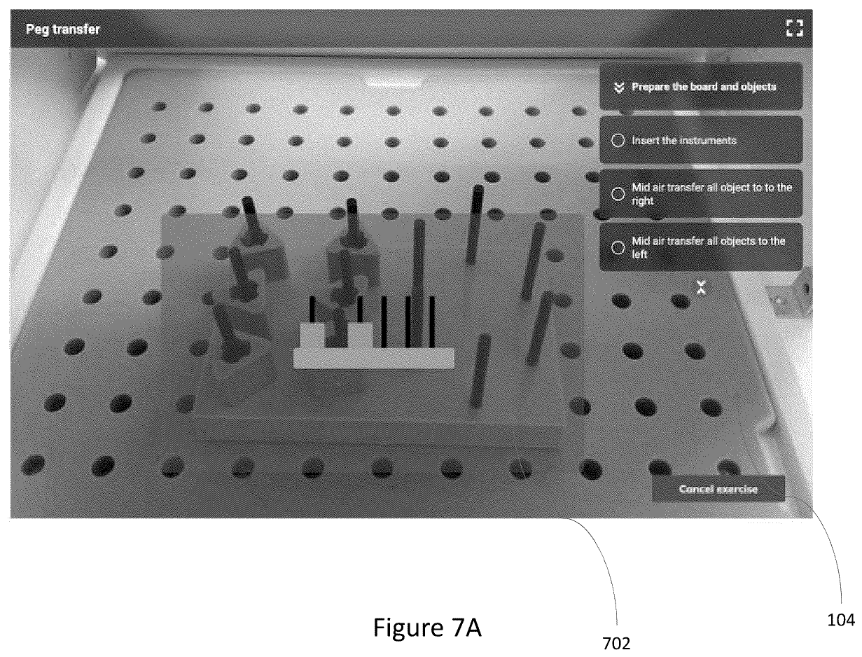

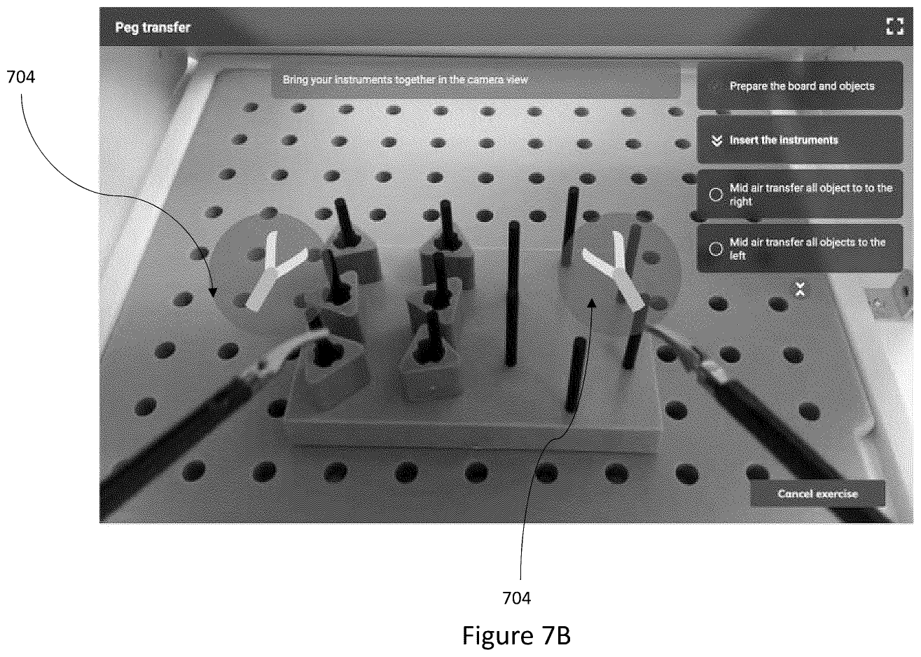

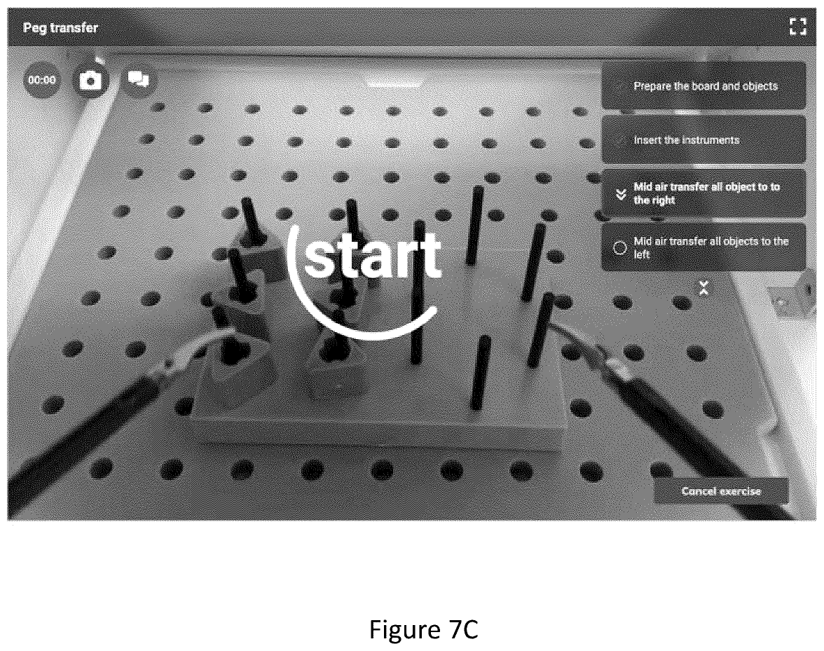

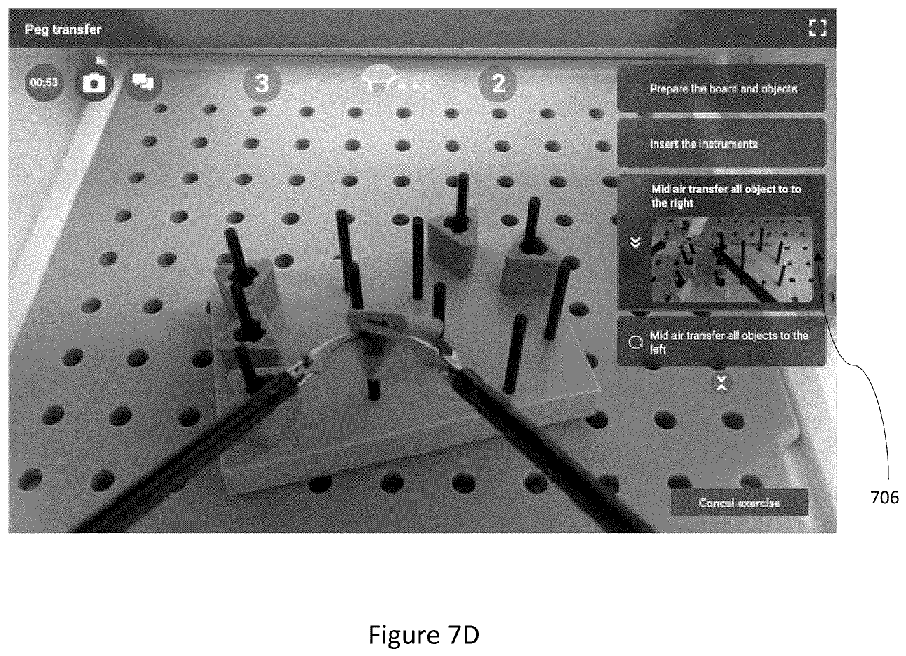

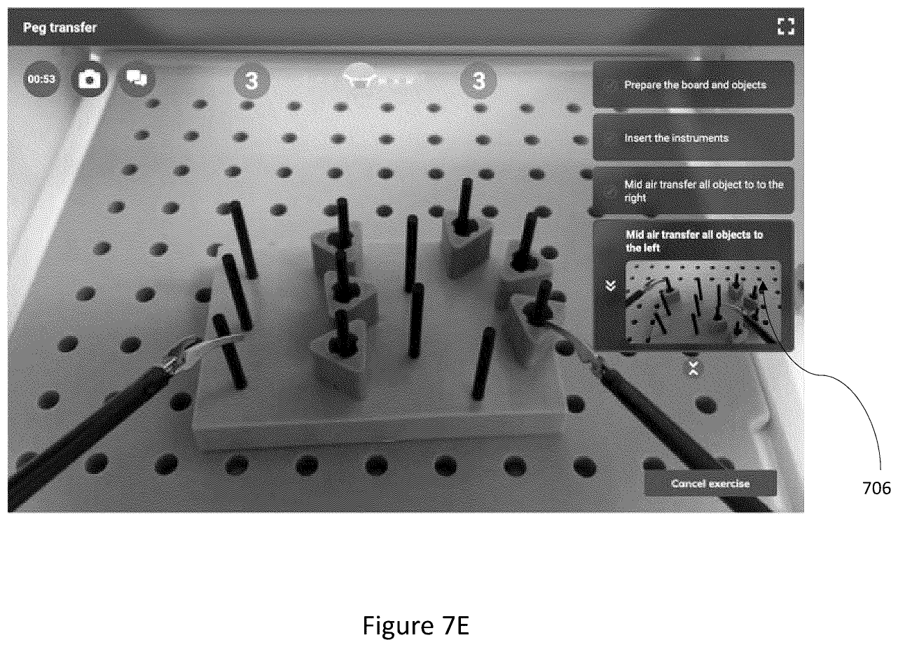

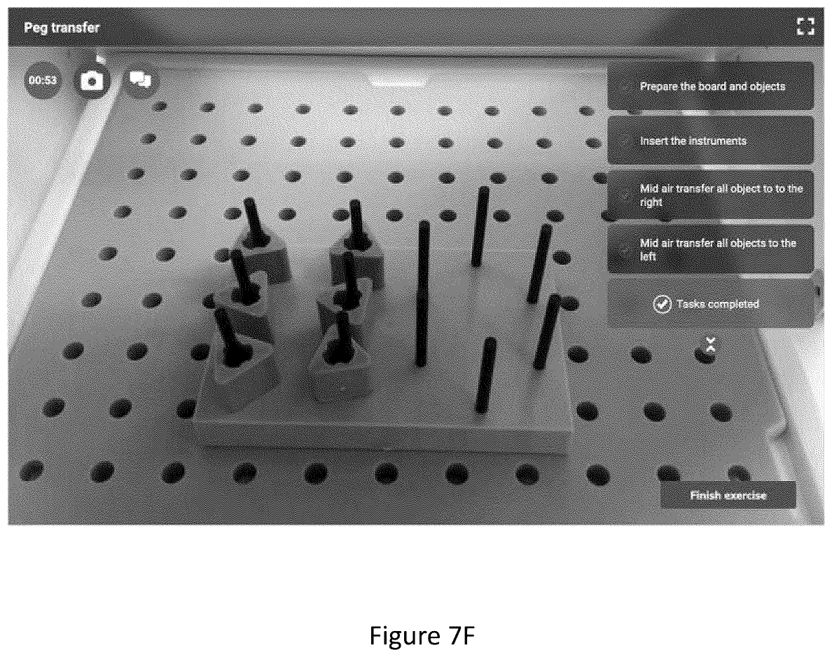

FIG. 5 is a representation of the modular structural frame 100 that is fully collapsed by rotating the back portion 118 towards the front portion about hinge 114 in a clam shell fashion. In some instances, an internal cavity is formed between the front portion 116 and the back portion. In some instances, this cavity is sufficiently large to store the adjustable platform 106, removed in FIG. 2. In other instances, the internal cavity is sufficiently large to store the adjustable platform 106 and the test fixtures (e.g., 702, 802, 902, 1002, 1102, and 1202 illustrated in FIGS. 7A, 8A, 9A, 10B, 11B, and 12B, respectively) that engage the peg board 104.

Accordingly, FIGS. 2-5 illustrate the process of collapsing the modular structural frame is illustrated in a series of stages. In the first stage, shown in FIG. 2, the adjustable platform is decoupled from the front portion of the frame, and the flange pivots about a hinge to disengage from the front portion and move toward the pegboard. This pivoting action sets the foundation for further folding and compacting the frame. FIG. 3 depicts the second stage, where the flange is fully rotated and mechanically coupled to the pegboard, potentially using clips or grooves for secure attachment, ensuring that the components stay connected as the frame continues to collapse.

The subsequent stages focus on compacting the frame into a portable form. FIG. 4 shows the pegboard rotating about another hinge toward the back portion of the frame, bringing the flange along with it. In the final stage, represented in FIG. 5, the back portion rotates toward the front portion in a clamshell manner, creating an internal cavity. This cavity can be used to store the previously detached adjustable platform and various modules that engage with the pegboard. The fully collapsed structure ensures that the frame is compact and convenient for storage and transport, while maintaining space for key components of the training device.

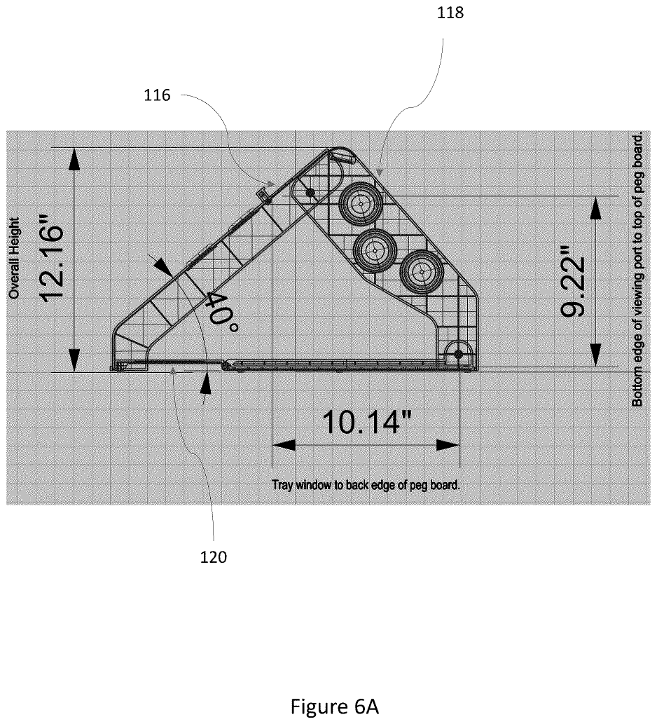

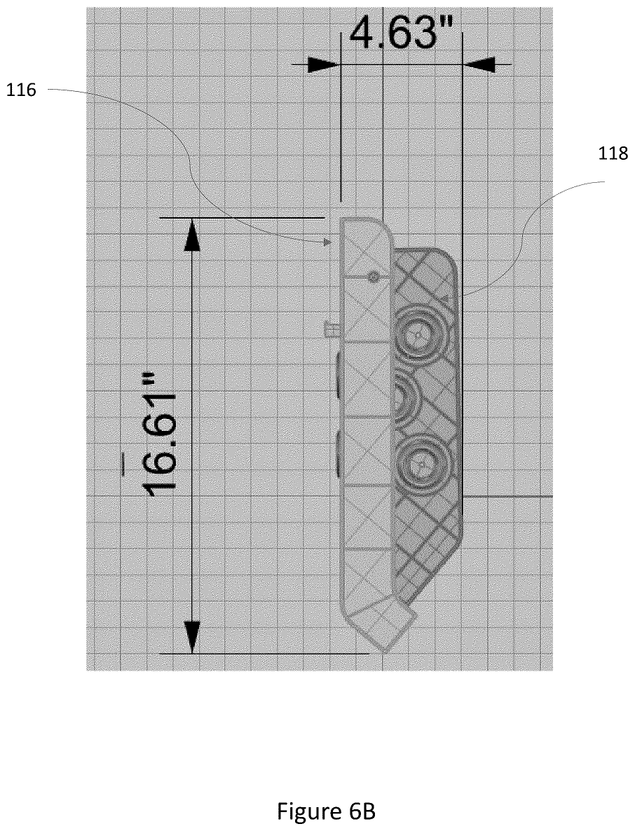

FIGS. 6A and 6B are schematic representations of the modular structural frame 100 that is fully assembled in accordance with embodiments of the invention. Specifically, FIGS. 6A and 6B illustrate example dimensions that may be utilized to make the modular structural frame 100. These dimensions are not fixed and can vary based on the specific requirements of the training setup. One important factor in determining these dimensions is the focal length of the cameras integrated within the tablet computer. The correct focal length ensures optimal image capture and realistic visualization of the training environment, which is essential for effective surgical simulation.

In some instances, the angle between the front potion and the flange 120 is less than 60 degrees and preferably 40 degrees. The reduced angle is deliberate, as it helps replicate the ergonomic positioning and spatial constraints that surgeons encounter during actual minimally invasive surgeries. By incorporating an angle that better mimics real-world conditions, the training device enhances the realism of surgical practice, ensuring that trainees develop the necessary muscle memory and skills in an environment that closely resembles an operating room setting.

Accordingly, embodiments of the modular structural frame 100 provide a realistic training environment for minimally invasive surgical procedures, constructed from lightweight and durable materials to simulate the confined spaces surgeons often work within. The frame features adjustable and strategically positioned trocar ports, allowing trainees to practice instrument insertion and ergonomic hand positioning similar to real surgeries, and it accommodates both left- and right-handed users, including ipsilateral port placement for added realism. Additionally, the frame's dimensions may be established, considering factors such as camera focal length to optimize visualization, and the ergonomic angles are designed to replicate the physical constraints surgeons face in operating rooms, making the simulation both practical and effective. In some instances, the dimensions of the frame are adjustable by the user using a telescoping feature (not shown).

The telescoping feature may be implemented by incorporating sliding or extendable segments within the front portion 116, back portion 118, and/or flange 120 of the frame 100. These segments can be designed to slide in and out of one another, allowing the user to adjust the length of the frame components to accommodate different training scenarios or user preferences. The telescoping mechanism may use interlocking or nested sections made from lightweight and durable materials, such as high-strength aluminum or reinforced polymers, to ensure stability and durability during use.

To lock the telescoping components in place after adjustment, the frame may incorporate mechanisms like locking pins, clamps, or twist-lock systems. In these instances, the mechanisms secure the frame at the desired length and prevent unintentional movement during training exercises. In some instances, the user adjusts the frame's dimensions easily by releasing the locking mechanism, extending or retracting the segments to the desired position, and then re-engaging the lock to maintain the new configuration. This adjustable design allows for ergonomic customization and optimal camera alignment, enhancing the realism and effectiveness of the surgical training environment.

The manufacturing of the modular structural frame 100 may involve a series of carefully planned processes to ensure that the final product meets the specifications for durability, portability, and realism in surgical training. The frame is constructed from lightweight yet durable materials, such as high-strength aluminum, composite plastics, or reinforced polymers, achieving a balance between sturdiness and easy handling. In some instances, these materials are molded or machined to form the primary components, including the front and back portions, pegboard base, adjustable platform, and supporting flanges. Each component is designed with precision, featuring pre-drilled holes or slots to assemble adjustable and strategically positioned trocar ports, for example as shown if FIGS. 6A and 6B. These ports are manufactured with exact angles and placements to replicate realistic laparoscopic instrument insertion, accommodating both right- and left-handed trainees.

Once the structural components are fabricated, they are assembled using high-quality mechanical hinges and interlocking mechanisms. The hinges are engineered to endure repeated folding and unfolding without losing performance, using corrosion-resistant metals or robust polymer composites. The pegboard is integrated into the frame's base and equipped with mounting options for various training modules like simulated organs or practice fixtures, secured through molded grooves or attachment clips. Adjustable elements, such as the platform for mounting a tablet, are connected using quick-release clamps or sliding locks, allowing for easy positioning and secure attachment. The tablet platform and the dedicated port for camera alignment are manufactured with precise dimensions to ensure optimal image capture and seamless integration with the AR software.

Additional features, such as the rechargeable light source, are integrated into the frame during assembly. The light source is installed with controls that interface with the tablet software, enabling adjustable brightness and color settings to simulate different operating room environments. Reflective surfaces, such as mirrors, are affixed to inner areas of the frame to provide additional angles for performance monitoring, using strong adhesives or brackets to secure them. The collapsibility of the frame is tested to ensure it folds smoothly and securely into a compact form. The folding mechanism is carefully engineered to prevent damage or misalignment, using locking hinges and clips to maintain the structure's integrity during transport. Quality control checks are conducted throughout the manufacturing process to guarantee each frame meets rigorous standards for surgical training.

The software integrated into the surgical training device is designed to provide an immersive and interactive learning experience through the use of AR and AI. Leveraging the tablet computer's camera, the software captures real-time video images of the user's surgical maneuvers within the enclosed training area. The AR technology overlays instructional graphics and text onto the live video feed, offering step-by-step guidance for a variety of laparoscopic tasks, such as object manipulation, tissue cutting, ligation, knot tying, and suturing. This real-time overlay ensures that users receive clear and contextual instructions, enhancing their understanding of each procedure.

Artificial intelligence plays a crucial role in the software by analyzing the video feed to assess the user's performance. The AI algorithms are programmed to evaluate key performance metrics, including precision, speed, and technique. Based on this analysis, the system provides immediate feedback, highlighting any errors and suggesting improvements. The feedback is tailored to the user's performance, allowing for a more personalized and effective training experience. Additionally, the software categorizes users into skill levels—beginner, intermediate, or expert—based on their proficiency, helping them understand their progress and identify areas that need further practice.

Beyond real-time guidance and feedback, the software also includes a robust data tracking and management system. User performance data is securely stored in the cloud, enabling trainees and instructors to review progress over time. This cloud-based storage allows for easy access from multiple devices and facilitates remote training and assessment, making it ideal for large-scale training programs. Instructors can review recorded sessions, quickly identify areas where trainees are struggling, and provide additional support as needed. This comprehensive system reduces the need for in-person proctors and makes surgical training more efficient and scalable, ultimately improving skill development across diverse learner populations.

FIGS. 7A-7F illustrate an example of the user interface that is shown on the table for the interactive learning experience for a module that trains for the peg transfer task. Specifically, the figures show an AR environment that utilizes overlays 704 to provide a structured and step-by-step surgical training exercise utilizing the frame the modular structural frame 100. The AR environment requires the learning software to be loaded on the tablet and installed in the modular structural frame 100 using the adjustable platform 106 to position the camera of the tablet through dedicated port 108.

The trainee is guided through a series of tasks designed to simulate the coordination and dexterity required for laparoscopic surgery. The sequence begins with instructions to prepare the board and arrange the objects appropriately, setting up the environment for the exercise. As shown in FIG. 7A, the module then determines that the proper test kit 702 has been installed into the peg board 104. The trainee is then prompted to insert the surgical instruments through the designated trocar ports. As shown in FIG. 7B, an AR overlay 704 is then displayed that ensures they practice proper tool handling and positioning.

The core of the peg transfer exercise involves using laparoscopic instruments to transfer objects mid-air from one side to the other. Specifically, the trainee must lift each object off a peg on the left side with the left-side surgical instrument, transfer it mid-air to the right-side surgical instrument, and place it on a peg on the right side. The process is then repeated to move all objects back to the left side. This task emphasizes the user's precision, stability, and control, as the objects must remain suspended and secure throughout the transfer. The exercise requires the user to bring the instruments into the camera's view, ensuring that their actions can be monitored and analyzed for performance feedback.

The interactive module includes real-time features, such as a timer displayed on the screen, which tracks the duration of the exercise. The trainee's progress is visually represented, and they are given cues to start and finish the exercise. The module automatically determines when the surgeon has completed a step in the task and automatically moves to the next step, as illustrated in FIGS. 7D-7F.

Upon completing the tasks, the system logs the total time taken and indicates whether all tasks have been successfully performed. If at any point, the surgeon needs additional instructions, they can select embedded video 706 and be shown a video displaying the proper techniques, as illustrated in FIGS. 7D and 7E. In some instances, the embedded video 706 may automatically play based on either an elapsed time to complete a stage in the task or immediately after the determination that the prior state in the task was completed. In some instances, the embedded video 706 may be in the form of an animation, such as an animated Graphics Interchange Format (GIF).

This setup provides an effective means of practicing surgical skills, with the software offering structured guidance and the opportunity for repeated practice to improve proficiency and technique. In addition, at the end of the module the performance may be scored and the capabilities of the surgeon assessed. In many instances, the determination of the completion of the individual tasks and the scoring of the performances are performed using AI or ML.

Accordingly, FIGS. 7A-7F illustrate a user interface displayed on a tablet for the peg transfer training module, which uses an AR environment to deliver a structured and interactive learning experience. The AR software is loaded onto the tablet, which is installed on the modular structural frame using an adjustable platform to align the camera through a dedicated port. The training begins with step-by-step instructions, as shown on the upper left side of the figure, prompting the trainee to prepare the board and insert surgical instruments through the designated trocar ports. An AR overlay guides proper tool handling, and the core exercise involves using laparoscopic instruments to transfer objects mid-air from one side to the other, emphasizing precision and control. Real-time features, such as a timer and visual progress cues, enhance engagement, and the system automatically advances through steps when completed. Trainees can access embedded instructional videos for additional guidance, and the module uses AI or machine learning to assess performance, logging completion times and scoring proficiency to aid in skill development.

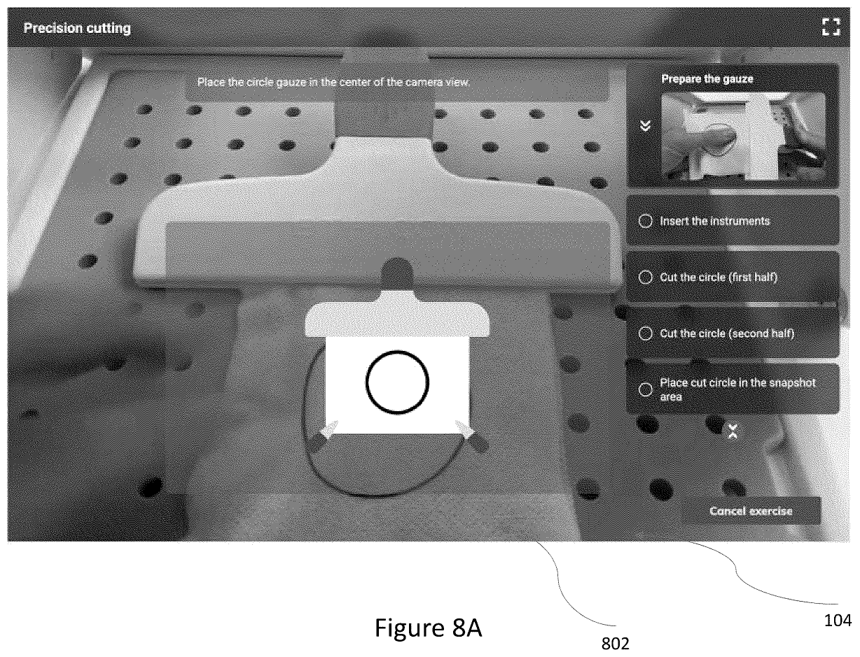

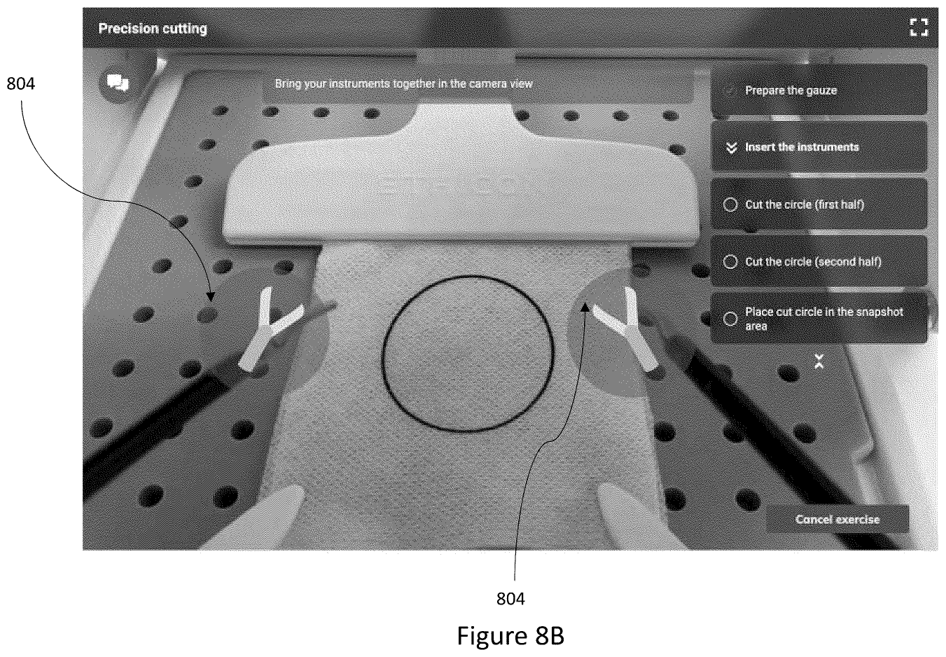

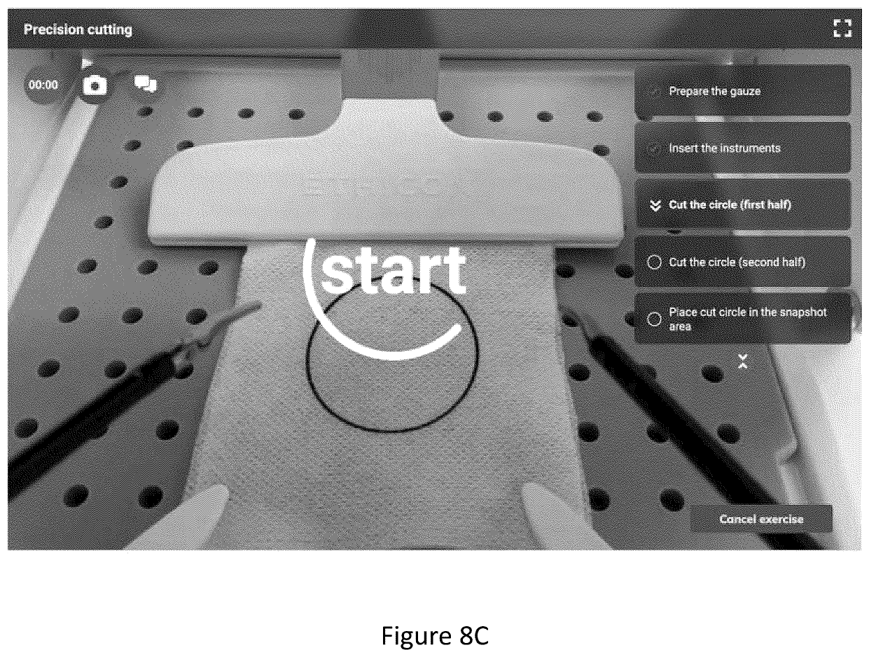

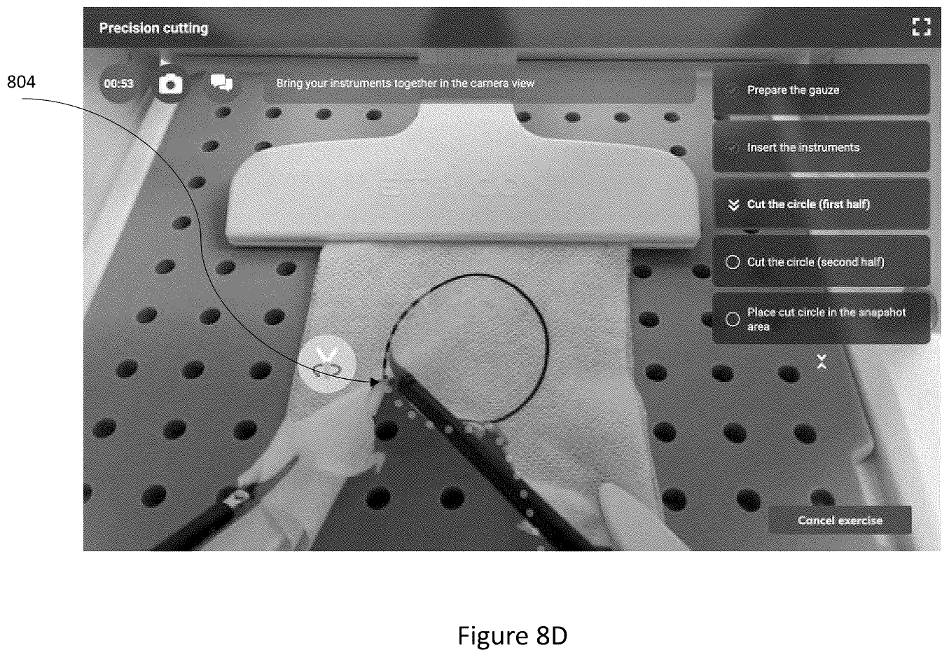

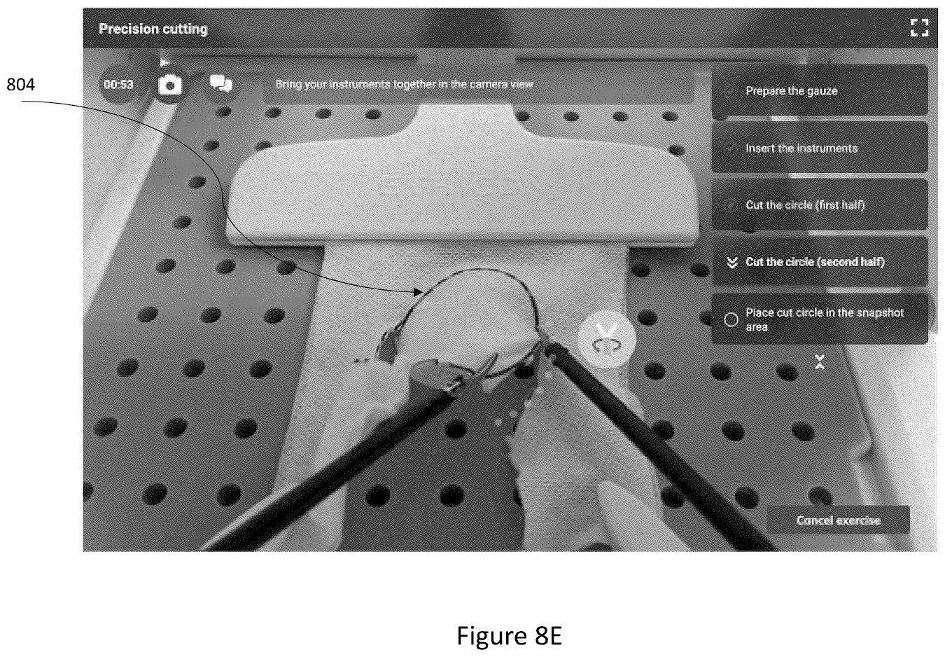

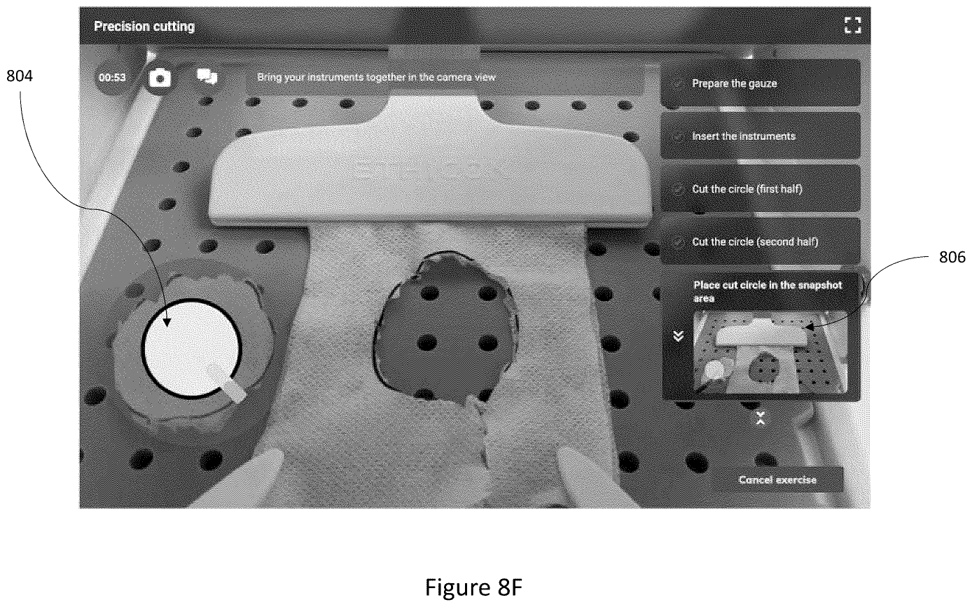

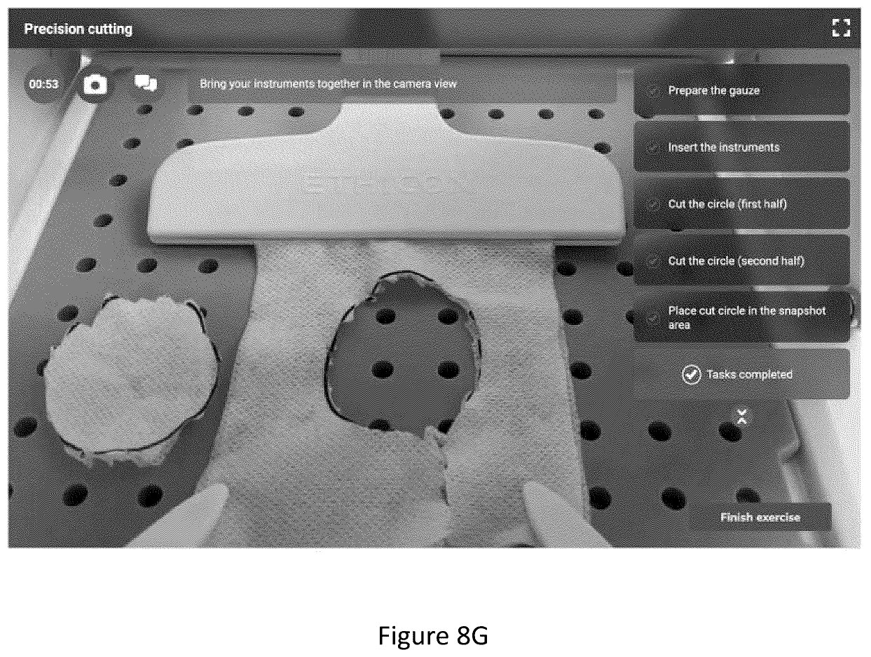

FIG. 8A-8G illustrates an example of the user interface that is shown on the table for the interactive learning experience for a module that trains for the precision cutting task. Specifically, the figures show an AR environment that utilizes overlays 804 to provide a structured and step-by-step surgical training exercise, as shown on the upper left side of the figures, utilizing the frame the modular structural frame 100.

The precision cutting module provides an interactive and detailed surgical training experience designed to enhance a trainee's fine motor skills and precision with laparoscopic instruments. The exercise begins with a series of structured instructions to ensure that the test fixture 802 is properly installed in the pegboard 104. The module then determines that the system is properly configured. Then, the trainee is first prompted to prepare a piece of gauze, ensuring it is properly positioned on the training surface to simulate real surgical conditions. Next, the trainee is instructed to insert the surgical instruments through the trocar ports in the training device, emphasizing proper instrument handling and positioning to mirror the setup of a laparoscopic procedure. Throughout the task, AR overlays 804 are shown to guide the surgeon.

The main task in this module involves carefully cutting a circle out of the gauze. This cutting exercise is divided into two phases: the first half of the circle is cut, followed by the completion of the second half. The instructions are specific, requiring the trainee to maintain a steady hand and precise movements to cut a smooth and accurate circle. The AR overlay on the tablet may provide visual guidance to assist with maintaining the correct path and pressure while cutting. This aspect of the exercise emphasizes the importance of precision, stability, and control, which are critical skills for surgical success.

After successfully cutting the circle, the trainee must place the cut piece in a designated “snapshot area,” where the system likely analyzes the quality of the cut for assessment purposes. The module includes real-time features, such as a visible timer that tracks how long the exercise takes, providing a benchmark for evaluating speed and efficiency. Visual prompts remind the trainee to keep the instruments within the camera's view, allowing the system to monitor and record their performance accurately. If, at any point, the surgeon needs additional instructions, they can select embedded video 806 and be shown a video displaying the proper techniques, as illustrated in FIG. 8F. In some instances, the embedded video 806 may automatically play based on either an elapsed time to complete a stage in the task or immediately after the determination that the prior state in the task was completed. In some instances, the embedded video 806 may be in the form of an animation, such as an animated Graphics Interchange Format (GIF).

Once all steps are completed, the trainee receives a confirmation that the tasks have been successfully executed, and they are prompted to bring the instruments together in the camera view to signal the conclusion of the exercise. In addition, at the end of the module, the performance may be scored, and the capabilities of the surgeon will be assessed. In many instances, the determination of the completion of the individual tasks and the scoring of the performances are performed using AI or ML.

Accordingly, FIGS. 8A-8G illustrate the structured user interface for the precision cutting module that is displayed on the table, highlighting an advanced AR environment that guides trainees through every step of the exercise using overlays. By ensuring proper system configuration and providing real-time guidance for instrument handling and gauze preparation, the module simulates realistic surgical conditions. The task emphasizes cutting a circle out of gauze with precision and control, supported by AR overlays that help maintain accuracy and reinforce critical surgical skills. Performance is closely monitored, with features like timers and visual prompts to aid in the assessment of speed and technique. If additional assistance is needed, embedded instructional videos are available. Upon completing all steps, AI and machine learning algorithms analyze and score the trainee's performance, offering an in-depth evaluation of their capabilities and fostering skill development.

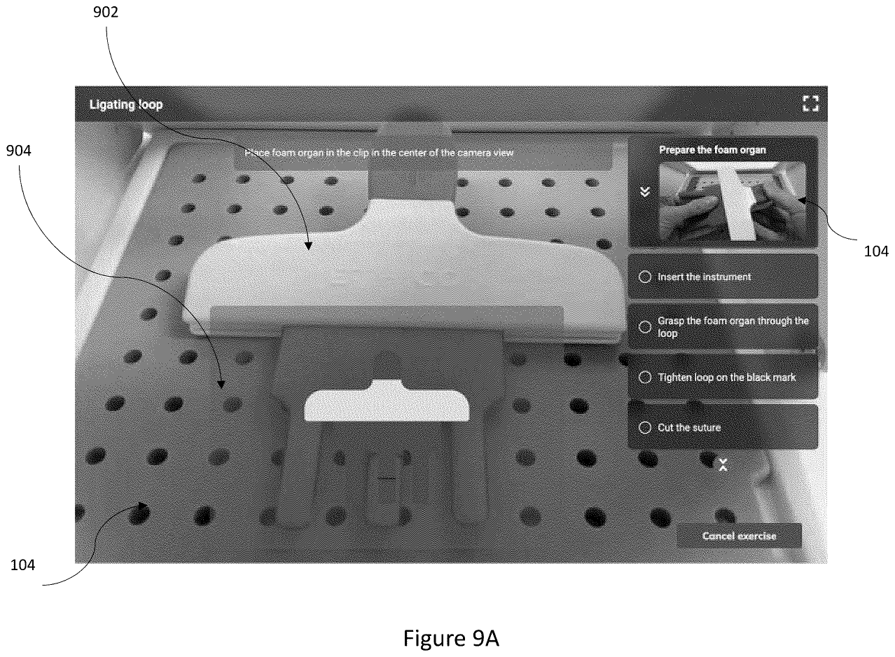

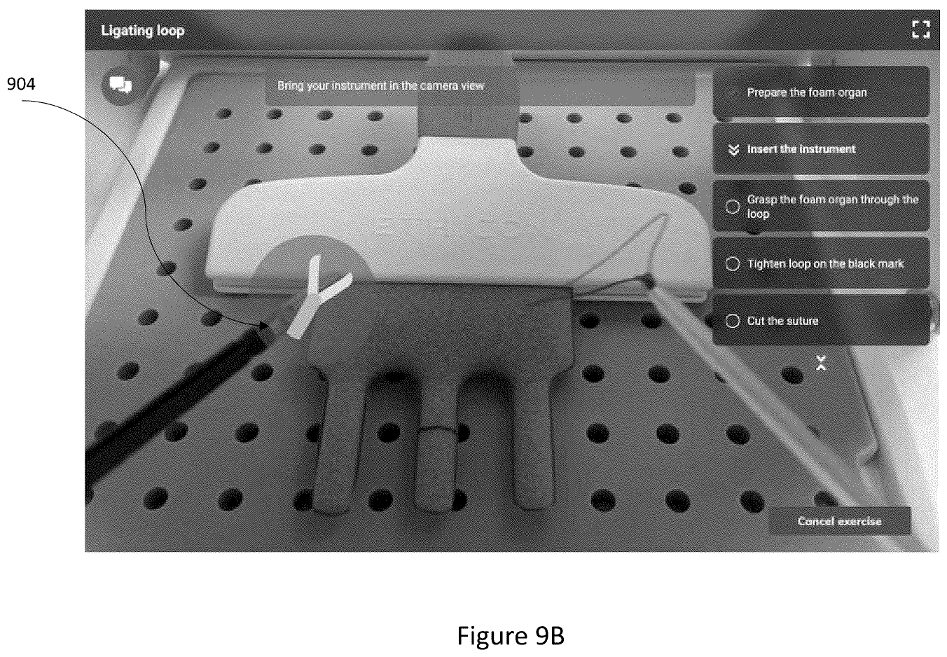

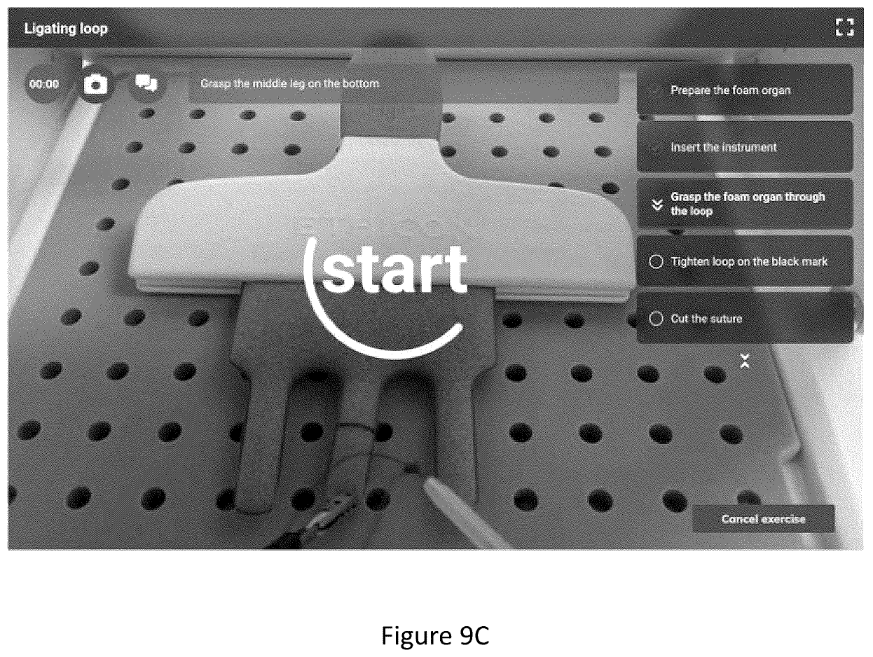

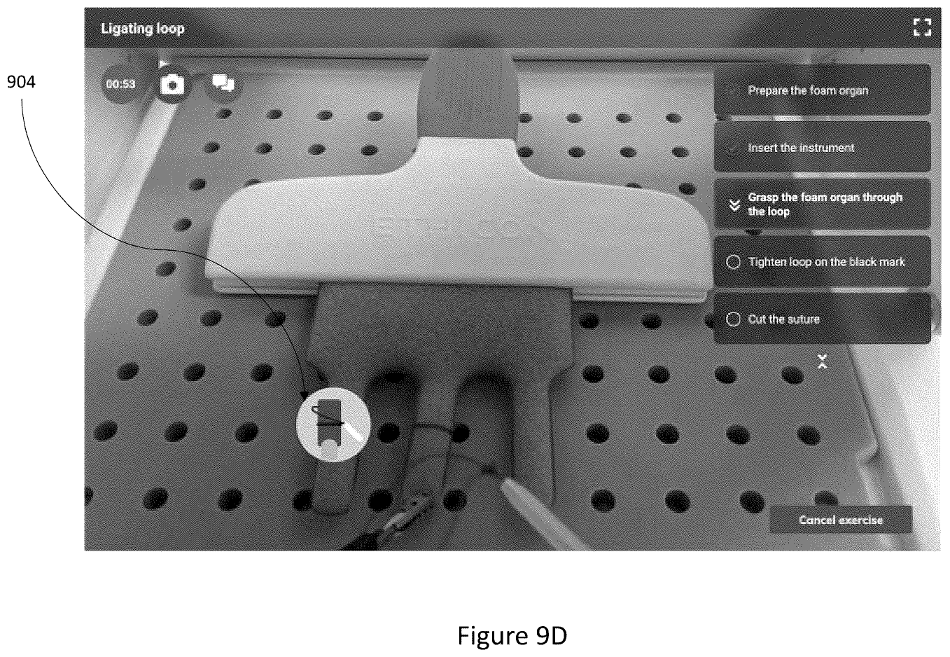

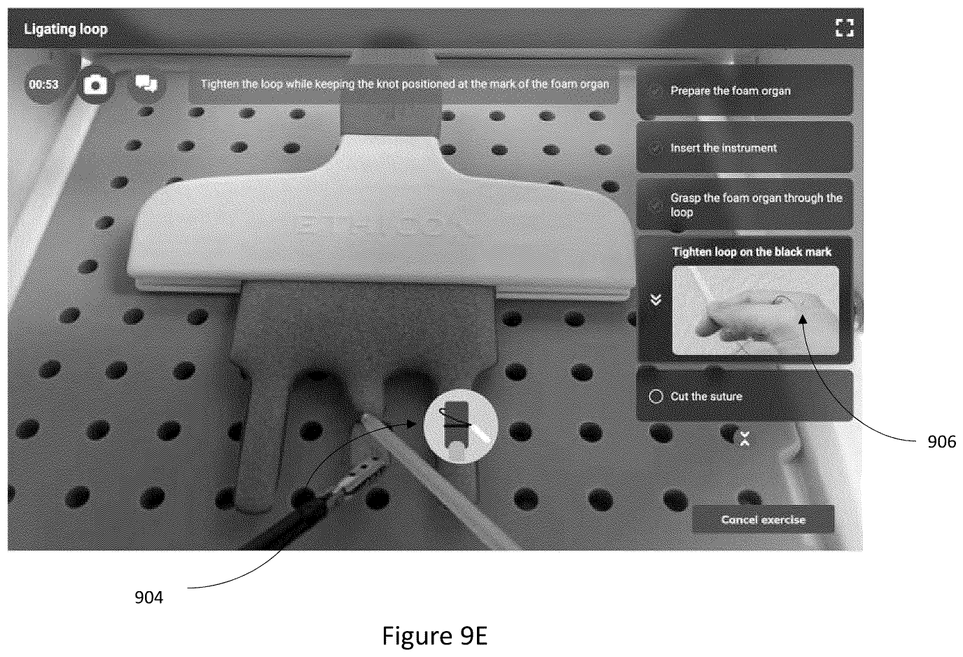

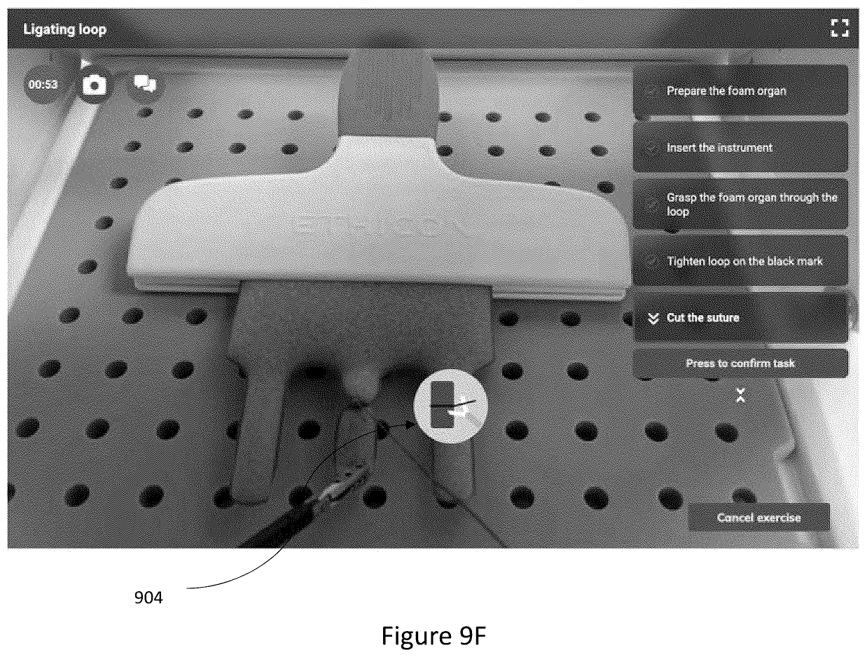

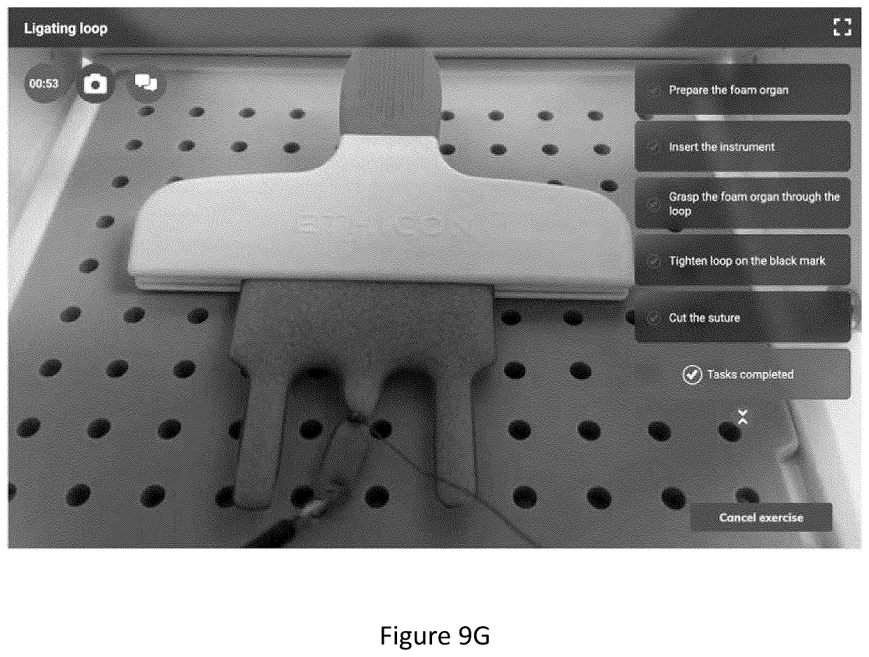

FIGS. 9A-9F illustrate an example of the user interface that is shown on the table for the interactive learning experience for a module that trains for the ligating loop task. Specifically, the figures show an AR environment that utilizes overlays 904 to provide a structured and step-by-step surgical training exercise, as shown on the upper left side of the figures, utilizing the frame the modular structural frame 100. The ligating loop module provides an interactive training experience designed to teach and refine the skills required for securely tying and tightening sutures during laparoscopic procedures. The exercise begins with the trainee being instructed to prepare a test fixture 902 (simulated foam organ) on the peg board 104, which serves as the practice material for the task. The trainee must then insert the surgical instrument through the designated trocar port and use it to grasp the foam organ through a pre-formed ligating loop.

Once the organ is secured within the loop, the trainee is guided to tighten the loop precisely on a black mark that indicates the target area. This step requires careful control to ensure that the loop is tightened properly without slipping or damaging the simulated tissue. After the loop is secured, the trainee must use the instrument to cut the suture, completing the ligation. Visual prompts and overlays 904 in the augmented reality (AR) environment provide guidance and ensure that the trainee maintains proper technique throughout the exercise. If, at any point, the surgeon needs additional instructions, they can select embedded video 906 and be shown a video displaying the proper techniques, as illustrated in FIG. 9E. In some instances, the embedded video 906 may automatically play based on either an elapsed time to complete a stage in the task or immediately after the determination that the prior state in the task was completed. In some instances, the embedded video 906 may be in the form of an animation, such as an animated Graphics Interchange Format (GIF).

The module features real-time performance tracking, including a visible timer that records how long the task takes, helping assess efficiency and speed. Trainees are prompted to bring their instruments into the camera view for monitoring and evaluation. The system also provides cues to confirm each step, such as ensuring that the loop is tightened at the correct mark and that the suture is cut cleanly. Once all tasks are completed successfully, the trainee receives confirmation, marking the end of the exercise. In addition, at the end of the module, the performance may be scored, and the capabilities of the surgeon will be assessed. In many instances, the determination of the completion of the individual tasks and the scoring of the performances are performed using AI or ML. This structured approach reinforces essential ligation skills, offering an effective means to practice and master suture techniques in a controlled and realistic training environment.

Accordingly, FIGS. 9A-9F depict an advanced and structured user interface for the ligating loop training module, showcasing an AR environment that provides real-time guidance and feedback to enhance laparoscopic suture-tying skills. By using overlays and visual prompts, as shown on the upper left side of the figures, the module leads trainees through each step, from preparing the simulated foam organ to securely tightening and cutting the ligating loop on a designated mark. The integration of augmented reality, embedded instructional videos, and performance tracking ensures that trainees receive comprehensive support and immediate feedback on their technique while AI and machine learning algorithms assess proficiency. This immersive and interactive approach provides a highly effective training tool, fostering the development of precise and reliable suturing skills in a realistic and controlled setting.

The simple suture intracorporeal knot module delivers an advanced and technically detailed training exercise aimed at perfecting the skill of tying secure intracorporeal knots using laparoscopic instruments. The exercise begins with explicit instructions to prepare the suture block and penrose drain, which act as simulated soft tissue, mounted on the pegboard for optimal practice conditions. The trainee is then guided to insert the laparoscopic instruments through the appropriate trocar ports, ensuring they are familiarized with correct instrument positioning and handling within a constrained operative environment.

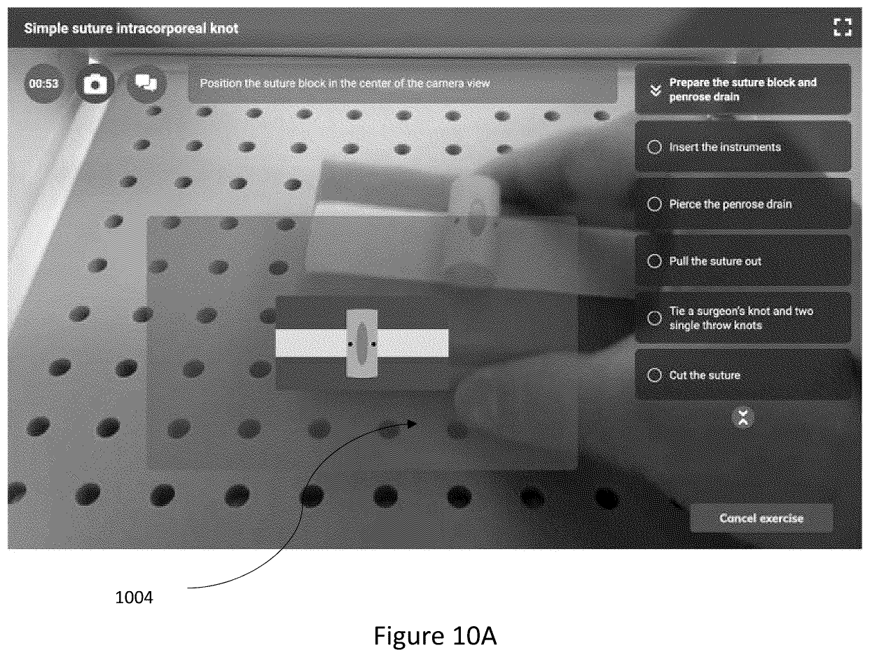

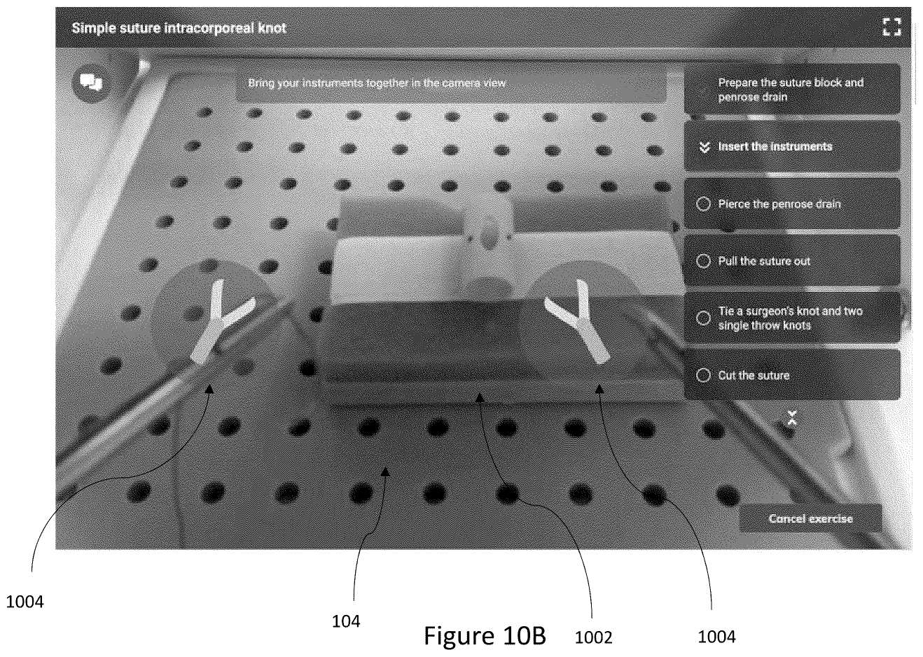

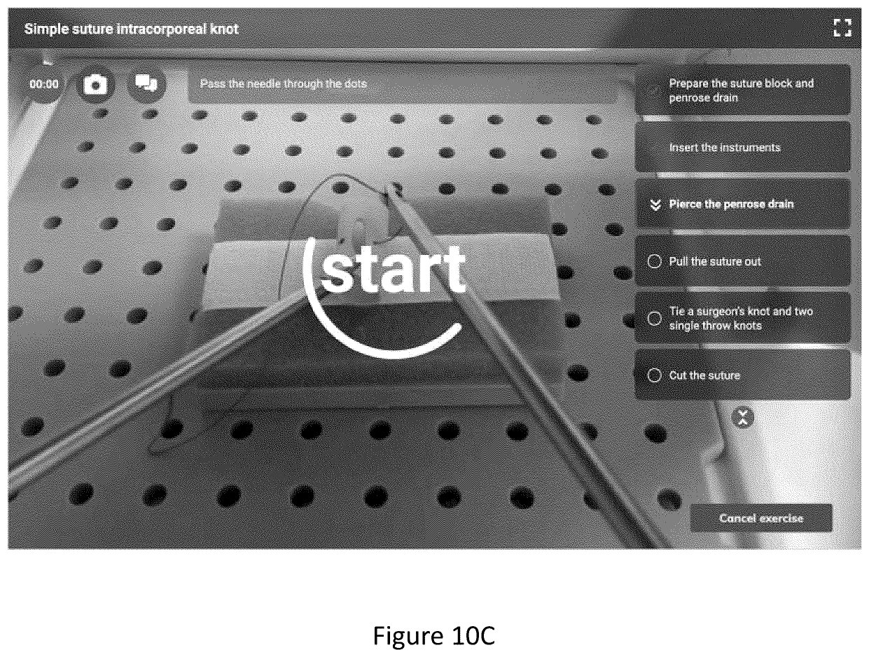

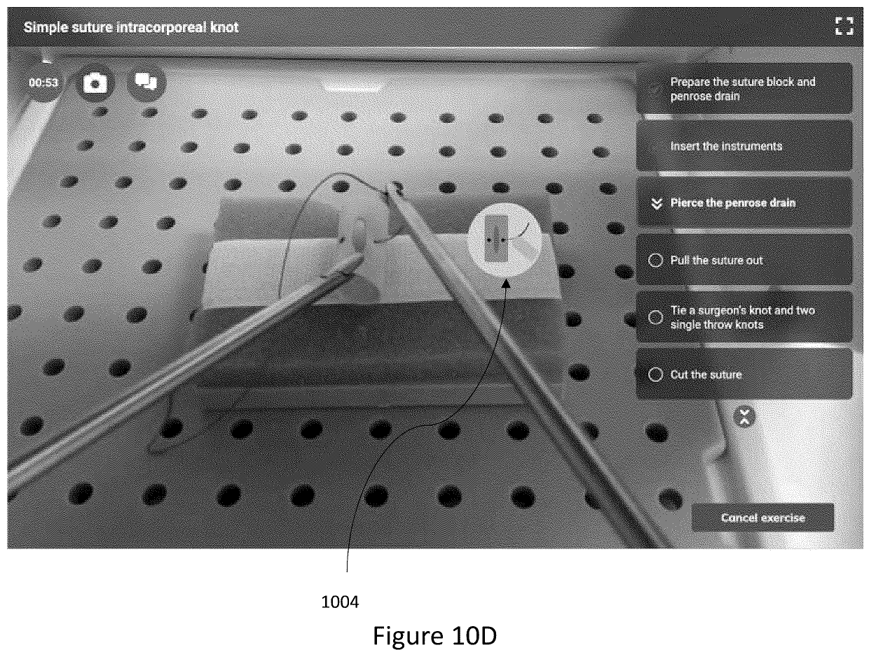

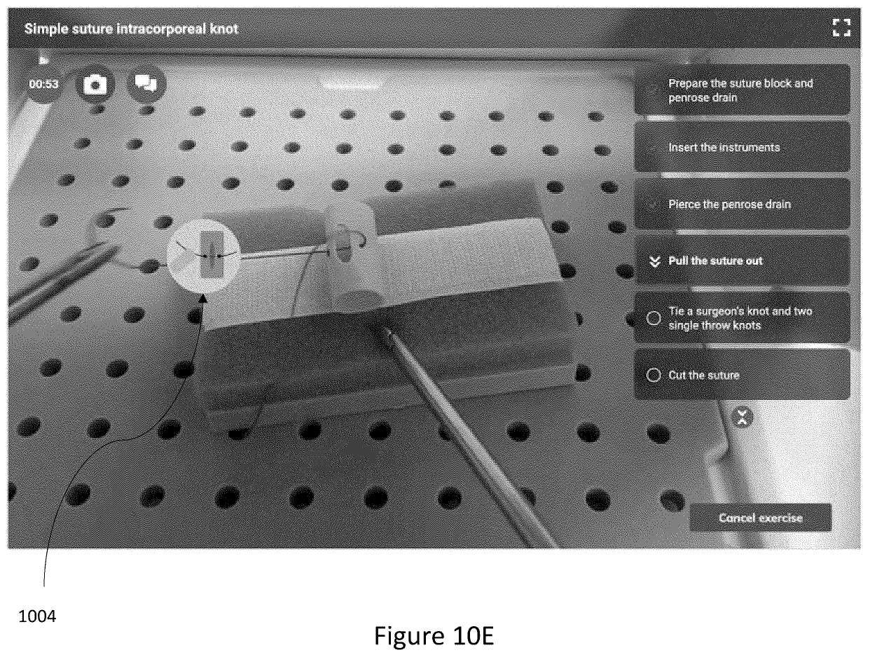

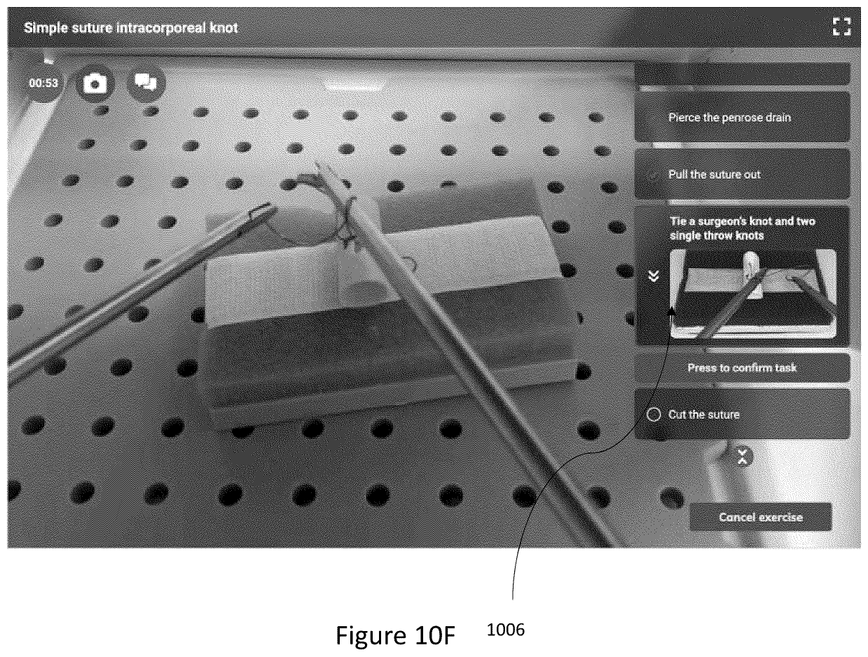

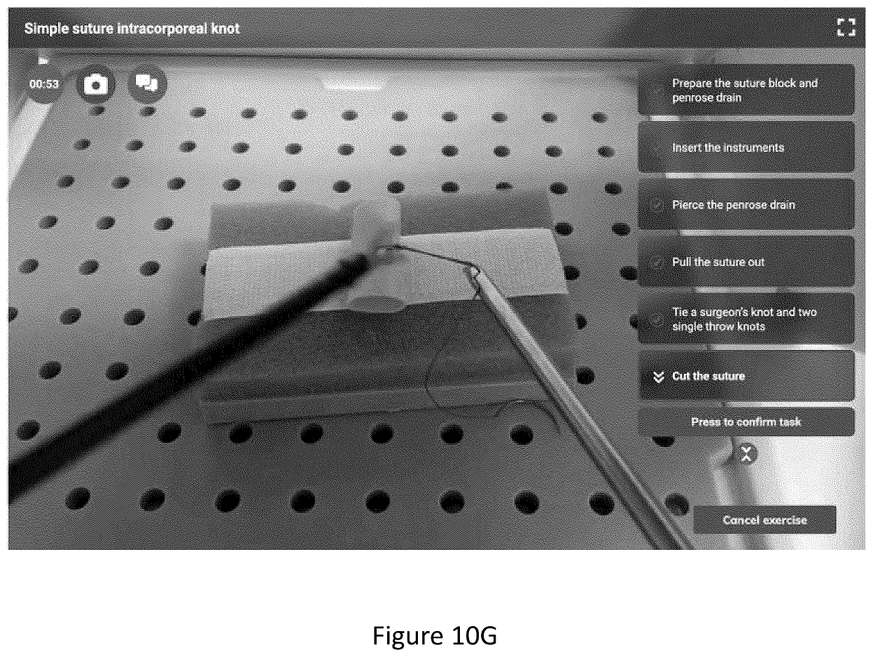

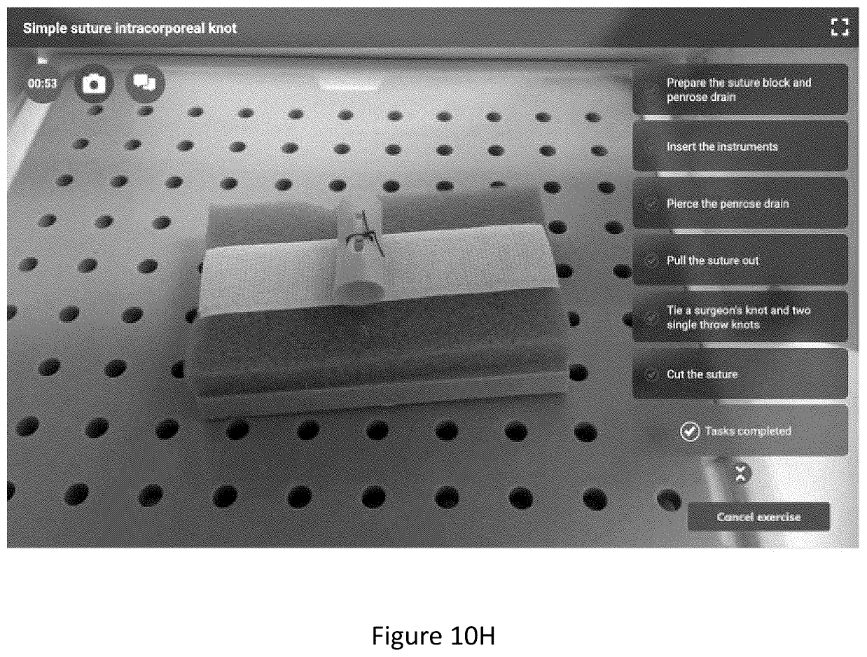

FIGS. 10A-10H illustrate an example of the user interface that is shown on the table for the interactive learning experience for a module that trains for the simple suture intracorporeal knot task. Specifically, the figures show an AR environment that utilizes overlays 1004 to provide a structured and step-by-step surgical training exercise utilizing the frame the modular structural frame 100.

The first step is to ensure that the trainee has properly installed the test fixture 1002 in the peg board 104. Then the first procedural step involves using the needle to precisely pierce the penrose drain, simulating tissue penetration, and subsequently pulling the suture material through the drain. This action is critical, as it replicates real-life tissue engagement and requires controlled instrument maneuvering. Following this, the trainee must execute a surgeon's knot intracorporeally, followed by two additional single throw knots to ensure a secure closure. The task emphasizes the importance of consistent suture tension and proper knot placement to prevent slippage or tissue damage. The AR overlay 1004 provides visual guidance and ensures that the trainee maintains the correct orientation and technique throughout the knot-tying process.

Performance metrics are continuously tracked, with a real-time timer recording the duration of the task to assess the trainee's efficiency. Visual prompts and feedback mechanisms remind the trainee to keep the instruments visible within the camera's field of view, which allows the system to monitor and analyze their technique. Once the knots are successfully tied and the suture is cut with precision, the system prompts the trainee to confirm task completion. If, at any point, the surgeon needs additional instructions, they can select embedded video 1006 and be shown a video displaying the proper techniques, as illustrated in FIG. 10F. In some instances, the embedded video 1006 may automatically play based on either an elapsed time to complete a stage in the task or immediately after the determination that the prior state in the task was completed. In some instances, the embedded video 1006 may be in the form of an animation, such as an animated Graphics Interchange Format (GIF).

This module utilizes embedded AI and machine learning algorithms to evaluate the accuracy, speed, and effectiveness of the trainee's performance, offering an in-depth analysis that enhances the development of critical laparoscopic suturing skills.

Accordingly, FIGS. 10A-10H depict the user interface for the simple suture intracorporeal knot module, which provides an advanced AR environment for structured, step-by-step surgical training, as shown on the upper left side of the figures, using the modular structural frame. The training begins with the proper installation of the test fixture on the pegboard, followed by the precise task of piercing a penrose drain with a needle and pulling the suture material through to simulate tissue penetration. The trainee is then guided to tie a secure intracorporeal surgeon's knot, followed by two single throw knots, emphasizing proper suture tension and knot placement to avoid slippage or tissue damage. Real-time performance metrics, such as task duration and instrument visibility, are tracked, while visual overlays and prompts help maintain the correct technique. Embedded videos are available for additional guidance, and AI and machine learning algorithms analyze performance, providing comprehensive feedback to refine the trainee's laparoscopic suturing skills.

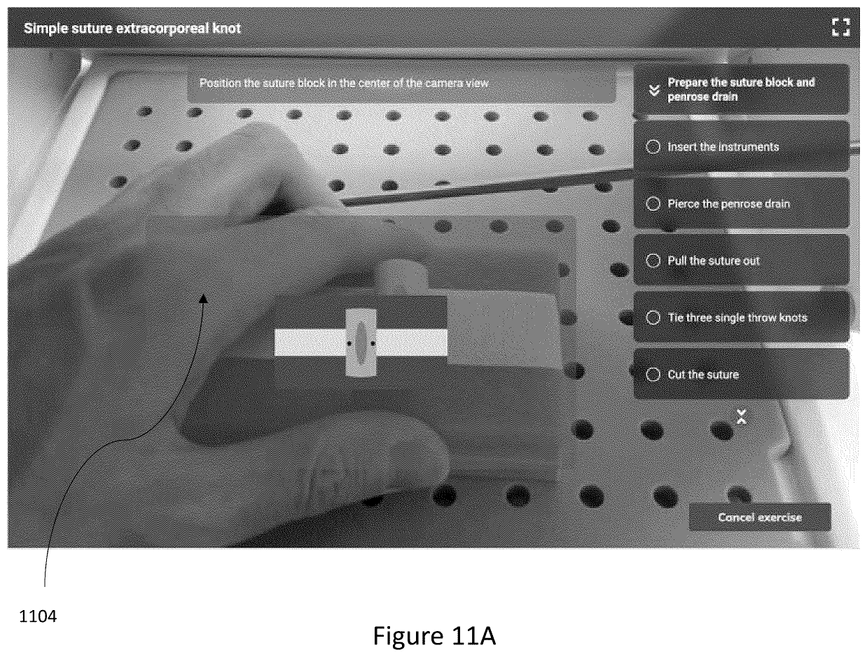

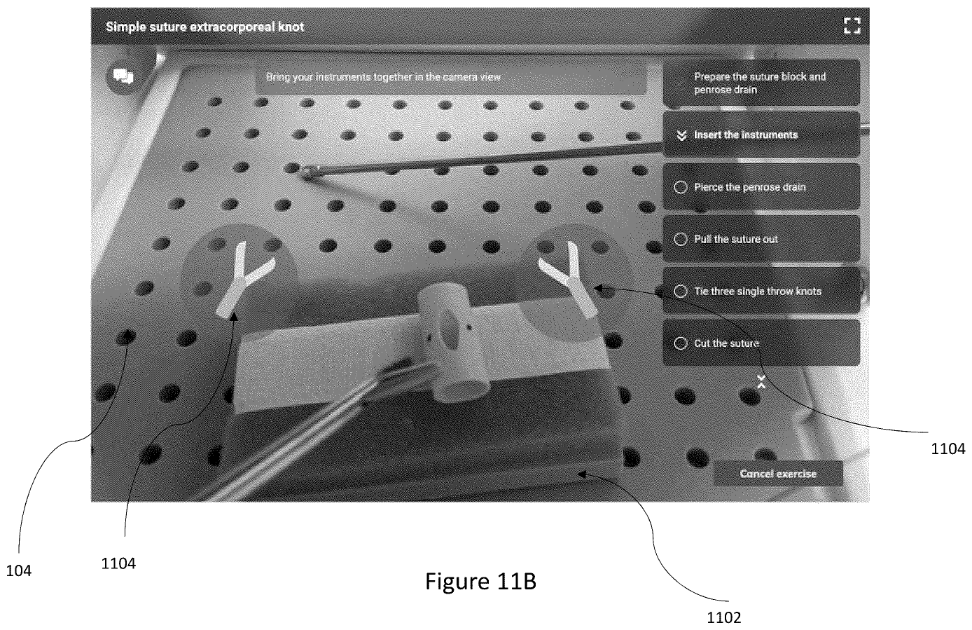

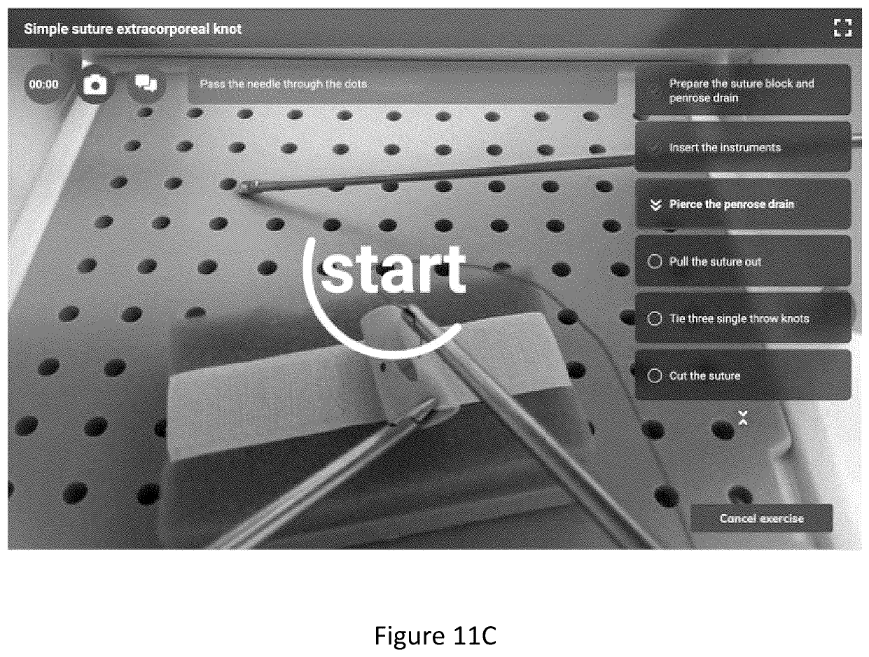

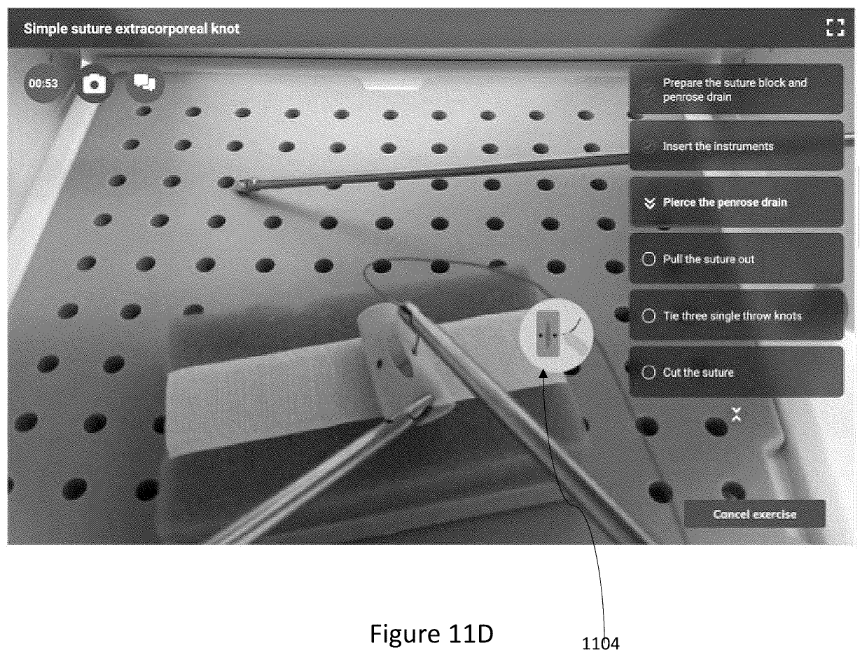

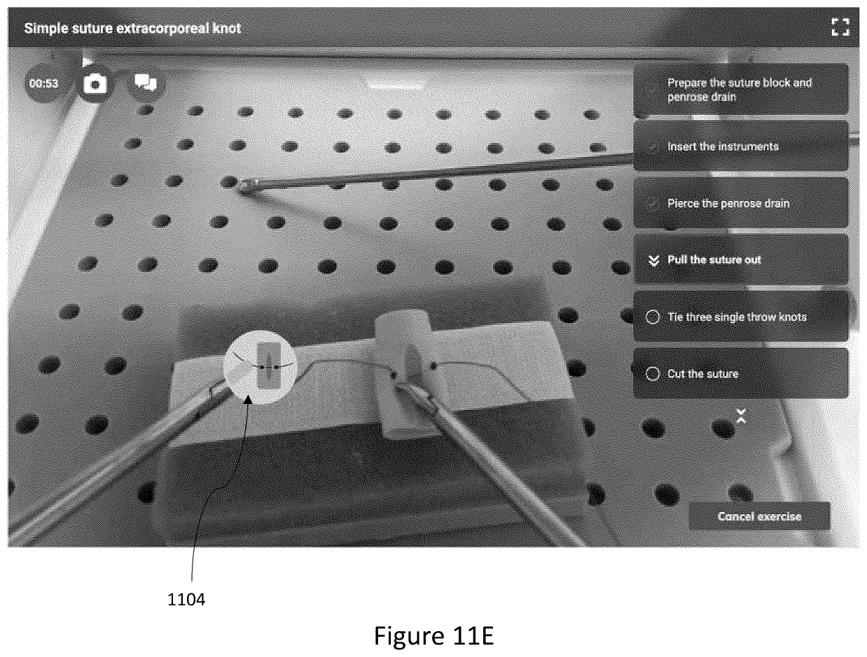

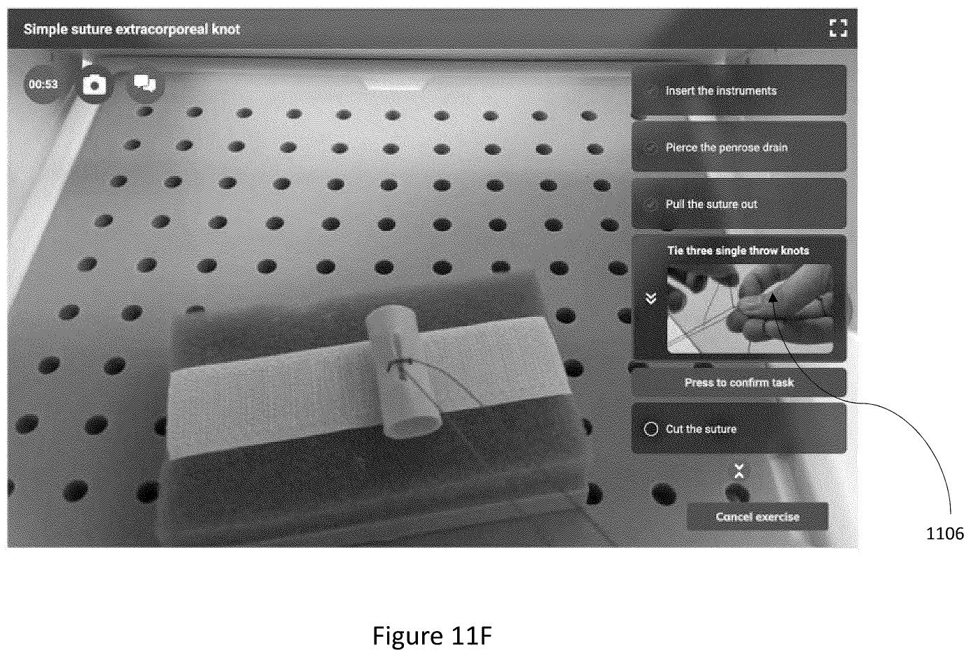

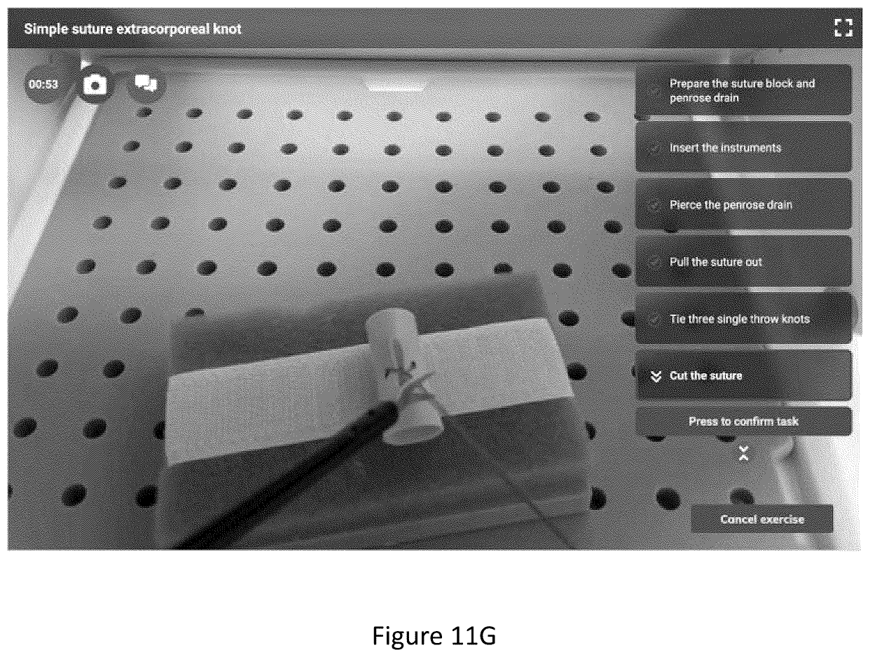

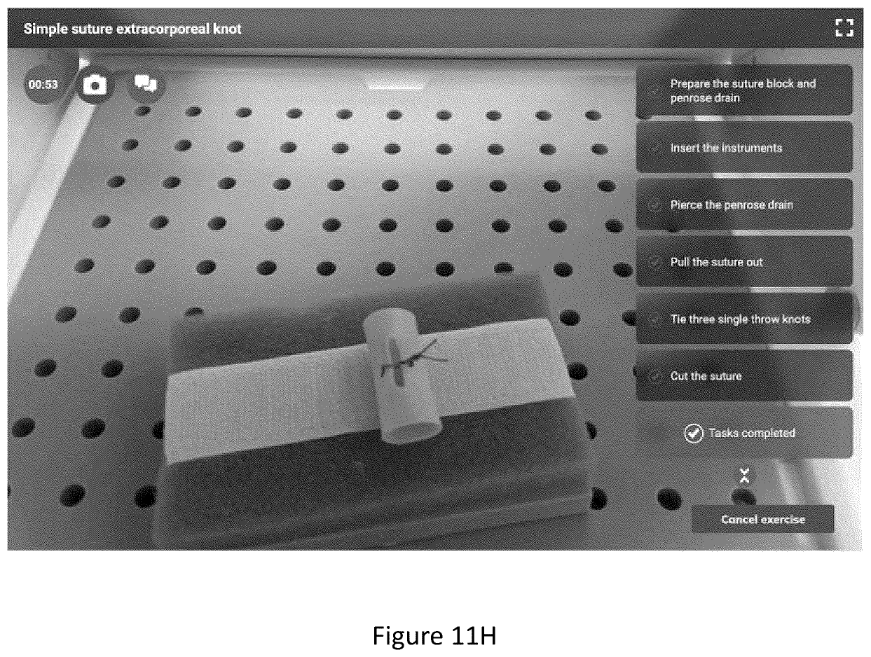

FIGS. 11A-11H illustrate an example of the user interface that is shown on the table for the interactive learning experience for a module that trains for the simple suture extracorporeal knot task. Specifically, the figures show an AR environment that utilizes overlays 1104 to provide a structured and step-by-step surgical training exercise utilizing the frame the modular structural frame 100.

The simple suture intracorporeal knot module delivers an advanced and technically detailed training exercise aimed at perfecting the skill of tying secure intracorporeal knots using laparoscopic instruments. The exercise begins with explicit instructions to prepare the peg board by installing the test fixture 1102 (suture block) and penrose drain, which act as simulated soft tissue, mounted on the pegboard for optimal practice conditions. The trainee is then guided to insert the laparoscopic instruments through the appropriate trocar ports, ensuring they are familiarized with correct instrument positioning and handling within a constrained operative environment.

The first procedural step involves using the needle to precisely pierce the penrose drain, simulating tissue penetration, and subsequently pulling the suture material through the drain. This action is critical, as it replicates real-life tissue engagement and requires controlled instrument maneuvering. Following this, the trainee must execute a surgeon's knot intracorporeally, followed by two additional single throw knots to ensure a secure closure. The task emphasizes the importance of consistent suture tension and proper knot placement to prevent slippage or tissue damage. The AR overlay 1104, as shown on the upper left side of the figures, provides visual guidance and ensures that the trainee maintains the correct orientation and technique throughout the knot-tying process.

Performance metrics are continuously tracked, with a real-time timer recording the duration of the task to assess the trainee's efficiency. Visual prompts and feedback mechanisms remind the trainee to keep the instruments visible within the camera's field of view, which allows the system to monitor and analyze their technique. Once the knots are successfully tied and the suture is cut with precision, the system prompts the trainee to confirm task completion. If, at any point, the surgeon needs additional instructions, they can select embedded video 1106 and be shown a video displaying the proper techniques, as seen in FIG. 11F. In some instances, the embedded video 1106 may automatically play based on either an elapsed time to complete a stage in the task or immediately after the determination that the prior state in the task was completed. In some instances, the embedded video 1106 may be in the form of an animation, such as an animated Graphics Interchange Format (GIF).

This module utilizes embedded AI and machine learning algorithms to evaluate the accuracy, speed, and effectiveness of the trainee's performance, offering an in-depth analysis that enhances the development of critical laparoscopic suturing skills.

Accordingly, FIGS. 11A-11H present the user interface for the simple suture extracorporeal knot module, featuring an AR environment with overlays that guide the trainee through a structured, step-by-step surgical training exercise, as shown on the upper left side of the figures, using the modular structural frame. The session begins with detailed instructions for preparing the pegboard by mounting the suture block and penrose drain, simulating soft tissue. The trainee is directed to insert the laparoscopic instruments through the trocar ports, ensuring proper positioning and familiarization with working in a constrained operative field. The procedure starts with using the needle to pierce the penrose drain, simulating realistic tissue engagement, followed by pulling the suture through. The trainee then ties a surgeon's knot extracorporeally, followed by two single throw knots, focusing on maintaining appropriate suture tension and precise knot placement to prevent tissue damage. AR overlays provide continuous visual guidance, and the system tracks performance metrics in real-time, including task duration and instrument visibility, while offering feedback and prompts. Embedded instructional videos are available for additional support, and the use of AI and machine learning allows for comprehensive analysis of the trainee's accuracy, speed, and overall effectiveness, enhancing essential laparoscopic suturing skills.

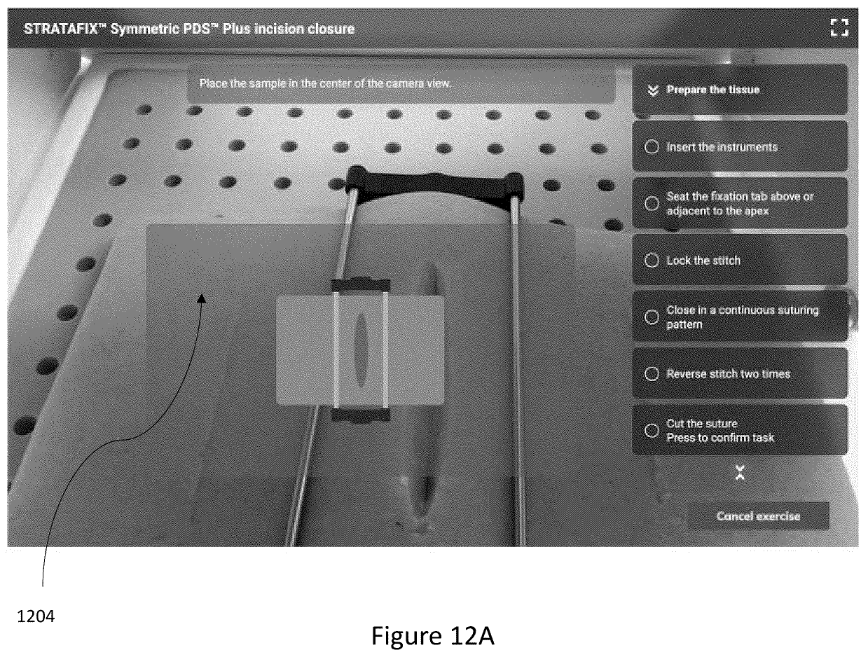

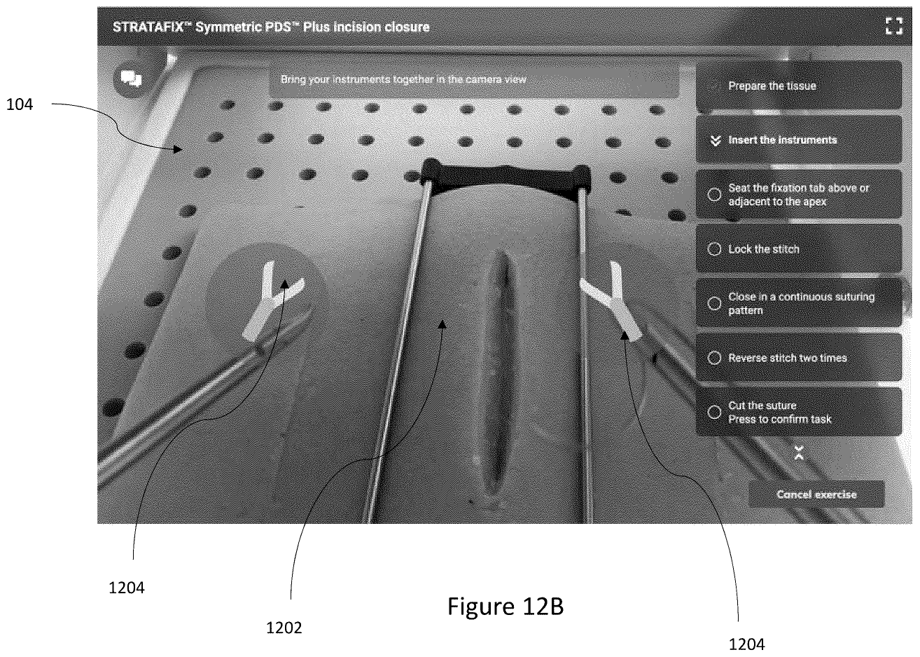

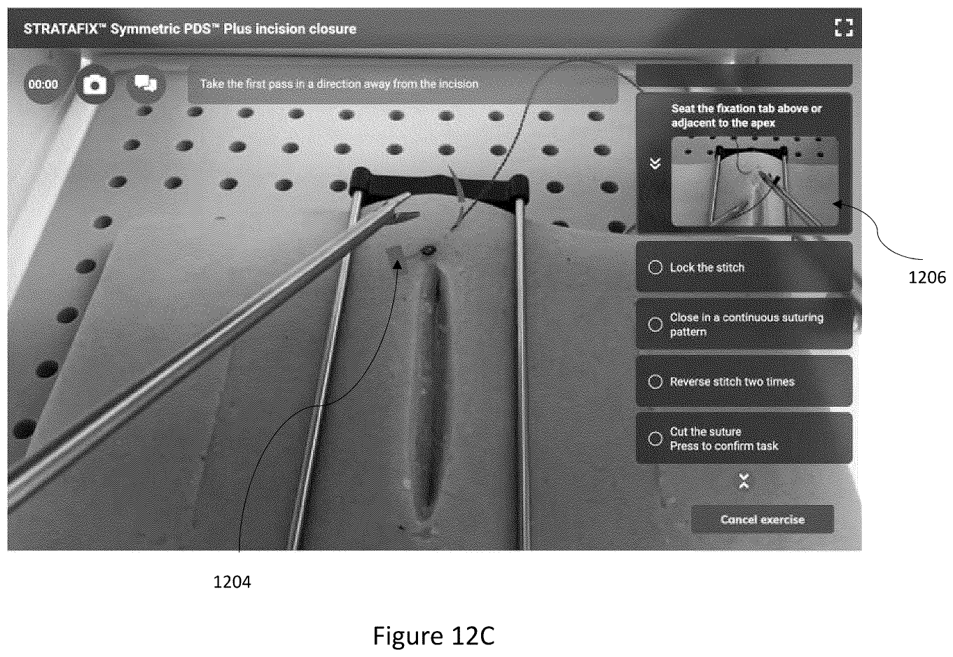

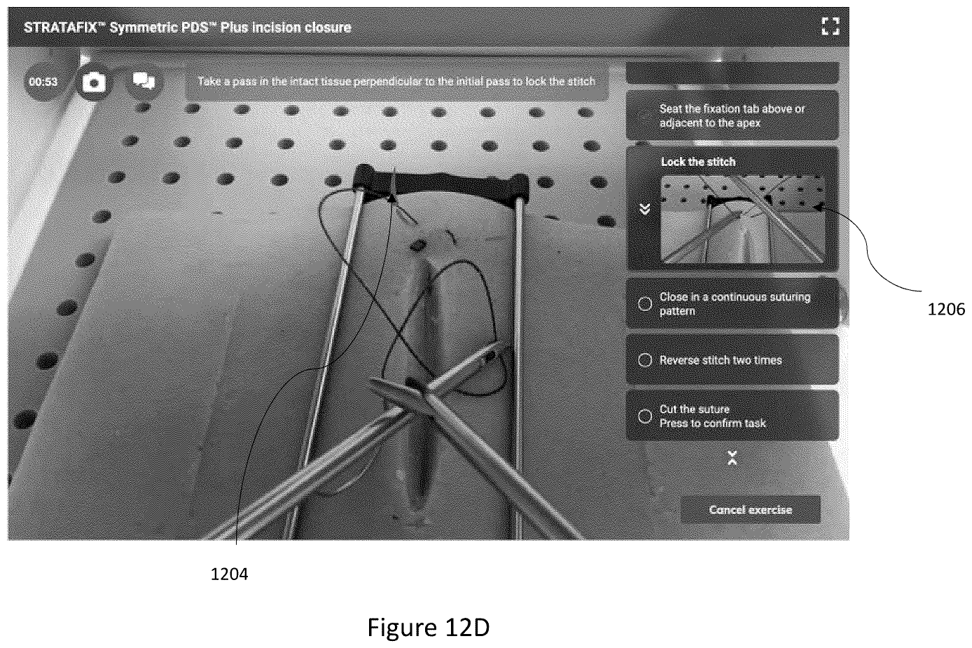

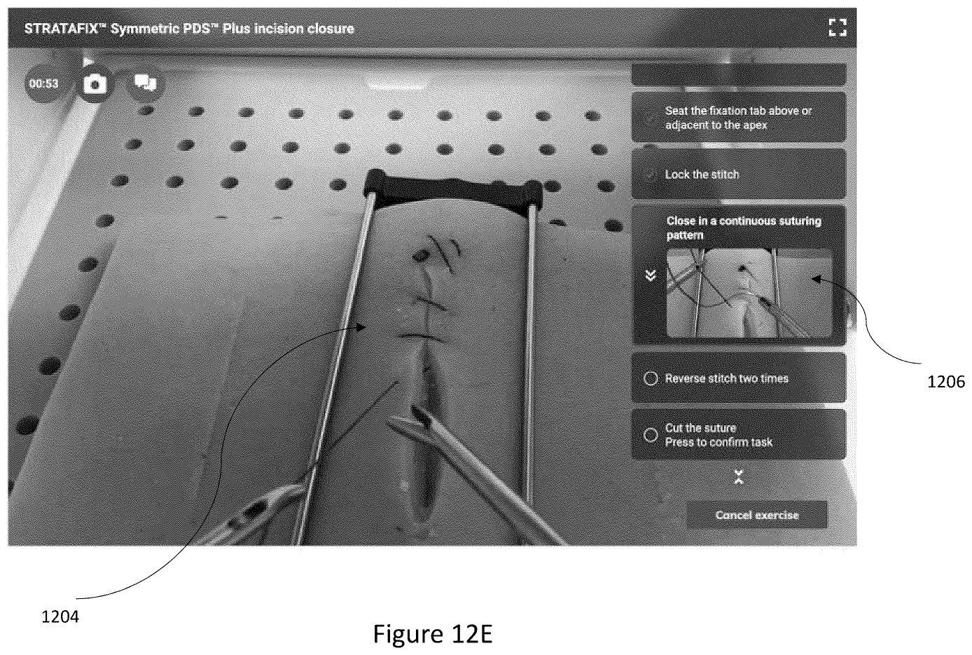

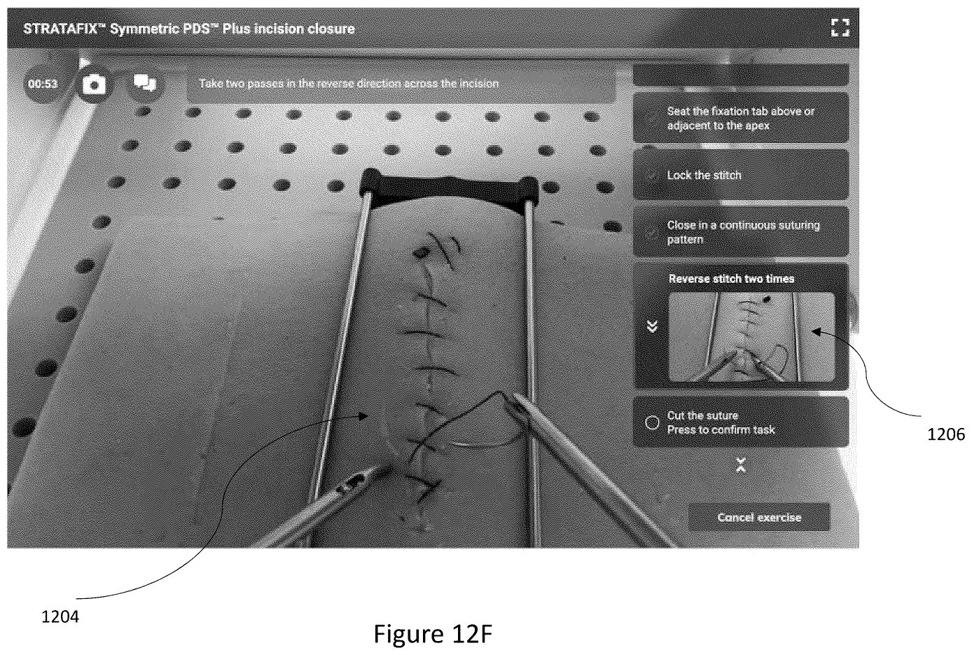

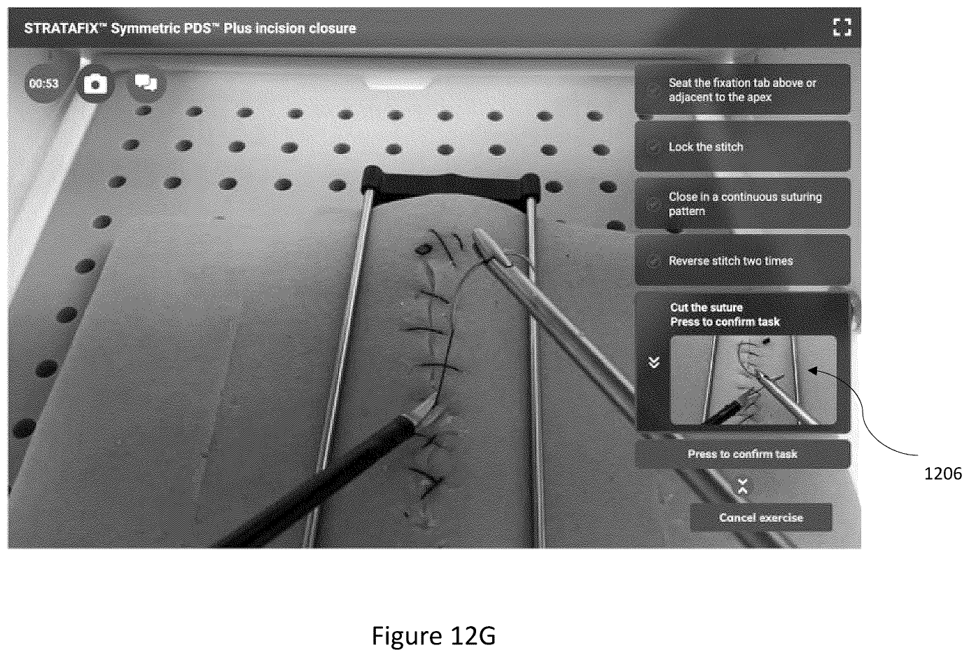

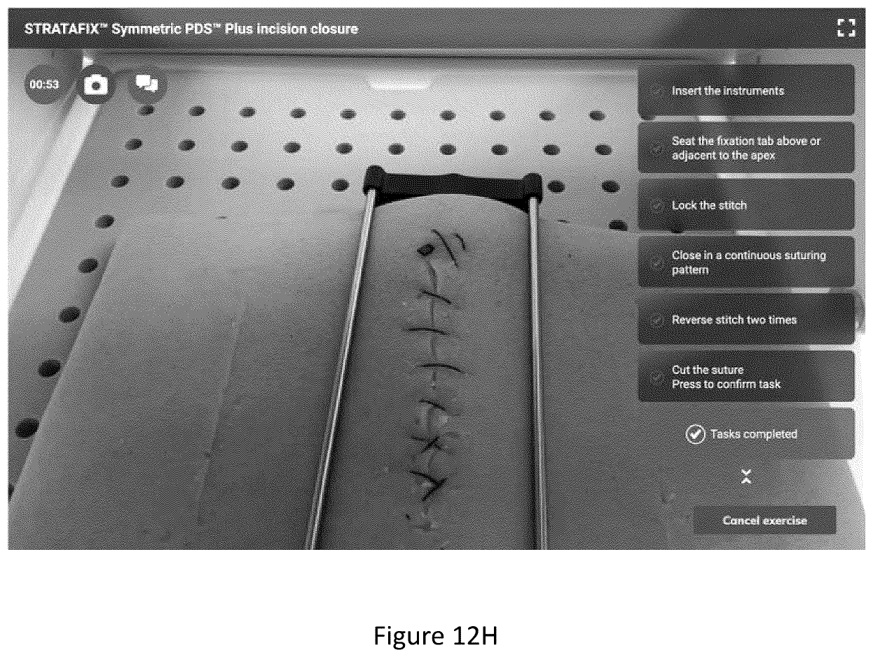

FIGS. 12A-12H illustrate an example of the user interface that is shown on the table for the interactive learning experience for a module that trains for The STRATAFIX™ Symmetric PDS™ Plus incision closure task. Specifically, the figures show an AR environment that utilizes overlays 1204, as shown on the upper left side of the figures, to provide a structured and step-by-step surgical training exercise utilizing the frame the modular structural frame 100.

Unlike the examples depicted in FIGS. 7-11, The STRATAFIX™ Symmetric PDS™ Plus incision closure task is not part of the FLS curriculum. Instead, the STRATAFIX™ Symmetric PDS™ Plus incision closure task demonstrates the flexibility of the embodiments of the invention to provide additional training to qualified surgeons using the same modular test frame 100. The STRATAFIX™ Symmetric PDS™ Plus incision closure module delivers a highly technical and immersive training exercise designed for mastering laparoscopic incision closure with absorbable barbed sutures. The training session begins with precise instructions for preparing the test fixture 1202 (multilayer skin pad) and securing it to the pegboard 104, simulating the soft tissue environment. The trainee is required to insert specific laparoscopic instruments, including two needle drivers, a Maryland dissector, and endoscopic scissors, through the trocar ports to ensure correct ergonomic setup and instrument handling.

The initial procedural step involves grasping the needle or the leader length of the STRATAFIX™ suture and positioning it on the simulated tissue. The trainee must accurately seat the fixation tab at or adjacent to the apex of the incision, ensuring it remains visible and above the tissue plane without exerting excessive force. Following this, the user locks the stitch by taking a suture pass away from the incision apex and perpendicular to the tissue plane, securing the tab and preventing suture slippage. This critical step ensures a firm anchor point for subsequent suturing.

The main suturing phase entails performing a continuous suturing pattern along the length of the incision, where the trainee takes opposing, evenly spaced bites on each side of the wound. This phase emphasizes controlled suture tension to achieve appropriate tissue approximation while avoiding overtightening, which could cause tissue damage. To secure the closure, the trainee must execute two reverse stitches across the incision to anchor the suture's terminal end, ensuring durability and integrity. The free end of the suture is then cut flush with the tissue surface using endoscopic scissors.

Throughout the exercise, AR overlays 1204 provide step-by-step visual guidance, ensuring correct technique and instrument orientation. The system employs real-time performance tracking, with a timer to evaluate the trainee's efficiency and built-in prompts to maintain instrument visibility in the camera's field of view for accurate monitoring. Trainees can access embedded instructional videos 1206 for additional support, as seen in FIGS. 12C-12G, and AI and machine learning algorithms analyze and score their performance, offering comprehensive feedback on accuracy, technique, and execution speed. This detailed and methodical training module ensures that trainees develop the proficiency required for effective and reliable laparoscopic incision closures, especially in high-tension tissue areas. In some instances, the embedded video 1206 may automatically play based on either an elapsed time to complete a stage in the task or immediately after the determination that the prior state in the task was completed. In some instances, the embedded video 1206 may be in the form of an animation, such as an animated Graphics Interchange Format (GIF).

The software integrated into the surgical training device improves laparoscopic skill development by providing a highly immersive, AR and AI-driven learning experience. Through the use of the tablet's camera, the software captures real-time video of the trainee's surgical maneuvers within the training area, overlaying instructional graphics and step-by-step guidance directly onto the live feed. This approach allows for an enhanced understanding of key procedures, such as object manipulation, tissue cutting, ligation, knot tying, and suturing, by offering contextual visual cues that help users master each task with precision.

AI plays a pivotal role in analyzing user performance, assessing essential metrics like precision, speed, and technique. The software provides immediate, personalized feedback based on this analysis, helping trainees correct errors and refine their skills efficiently. By categorizing users into skill levels ranging from beginner to expert, the system promotes targeted and effective practice, allowing individuals to track their progress and focus on areas requiring improvement. This intelligent, tailored feedback creates a more engaging and effective training experience, transforming traditional surgical education.

Beyond real-time guidance, the software features an advanced data management system that securely stores performance metrics in the cloud. This functionality allows trainees and instructors to review and assess progress over time, fostering continuous improvement. The ability to access data from multiple devices and perform remote assessments makes the platform ideal for large-scale training programs. By reducing the need for in-person proctors, the software not only enhances the efficiency of surgical training but also scales easily to accommodate diverse learner populations, ensuring the consistent development of critical laparoscopic skills.

The implementation of the software for the peg transfer training module involves an integrated use of AR and real-time performance analysis. The AR software is loaded onto an electronic tablet, such as an iPad, which is secured onto the modular structural frame using an adjustable platform that positions the camera through a dedicated port. This setup allows the camera to capture a clear view of the trainee's surgical field. Once the system is activated, the AR environment overlays visual cues and instructions directly onto the live video feed. The software ensures that the trainee is guided step-by-step, starting from preparing the pegboard with the correct test kit and inserting laparoscopic instruments through the trocar ports. These overlays are essential for demonstrating proper tool handling, positioning, and coordination, creating a comprehensive and interactive training experience.

To facilitate the peg transfer exercise, the software uses AR to guide the trainee in lifting and transferring objects mid-air between pegs on either side of the training board. This task emphasizes key laparoscopic skills, such as precision, stability, and control. The trainee must keep the instruments within the camera's view, enabling the system to monitor performance and provide feedback. The module's functionality includes a timer that tracks the exercise duration and visual progress cues that indicate when a step is completed. As each task is performed, the system detects completion and advances automatically to the next step. If the trainee requires further guidance, they can select embedded instructional videos that detail proper techniques, ensuring a thorough understanding of the procedure.

The software's AI component enhances the training experience by analyzing the captured video feed and evaluating metrics such as precision, speed, and technique. This analysis allows the system to deliver immediate and tailored feedback. For example, the system may automatically highlight errors and suggest areas for improvement. The AI algorithms also categorize the trainee's performance, providing an objective assessment of their skill level and logging this data in the cloud. This data management system enables trainees and instructors to review progress over time and perform remote assessments. By integrating AR and AI, the software delivers a scalable and efficient training solution, reducing the need for in-person proctors and allowing for repeated practice to develop critical laparoscopic skills.

In some instances, the software may be stored a non-transitory computer readable medium. A non-transitory computer-readable medium refers to any physical medium capable of storing data or instructions for use by a computer system in a stable and persistent manner. The term “non-transitory” emphasizes that the medium is not temporary or fleeting, distinguishing it from transitory signals such as data transmitted over the internet or electromagnetic waves. Examples of non-transitory computer-readable media include hard drives (both HDDs and SSDs), flash drives, CDs, DVDs, Blu-ray discs, memory cards, and ROM (Read-Only Memory) chips. These media are used to store software, programs, or data that can be accessed and utilized by a computer or electronic device. In legal and patent contexts, the term “non-transitory” clarifies that the claimed invention pertains to a tangible medium rather than an ephemeral or temporary form of data storage or transmission.

To effectively train a surgeon to pass the Fundamentals of Laparoscopic Surgery (FLS) exam using the described modular training device, a structured method is adopted that maximizes the benefits of augmented reality (AR) and artificial intelligence (AI) technologies. The modular structural frame is constructed from lightweight, durable materials designed to replicate the confined surgical environment encountered in minimally invasive procedures. It features a pegboard at its base and strategically positioned, adjustable trocar ports that can be configured for both ipsilateral and contralateral instrument insertion. This adjustability allows trainees to practice precise tool handling and ergonomic positioning, replicating the physical constraints of laparoscopic surgery. The frame also includes an adjustable platform to securely hold a tablet, with a dedicated port for optimal camera alignment, enabling real-time video capture of the trainee's actions.

The training process begins with the tablet's AR software guiding the trainee through various tasks, starting with simpler ones such as the peg transfer exercise. The AR overlays display instructional graphics directly onto the live camera feed, offering real-time visual cues that ensure proper tool handling and object transfer. In the peg transfer task, for instance, the trainee uses two Maryland dissectors to pick up six rubber rings (in the shape of triangles) from pegs on one side of the board, transfer them mid-air to pegs on the opposite side, and then repeat the process in reverse. The software imposes strict performance criteria, including no object drops outside the field of view and precise instrument control, which are critical skills for the FLS exam. The AR environment also features a built-in timer and progress indicators, tracking the duration of each attempt and automatically advancing to the next step upon successful completion.

The more advanced modules, such as precision cutting and knot tying, are designed to enhance the trainee's fine motor skills and hand-eye coordination. The precision cutting task involves using endoscopic scissors and a Maryland dissector to cut a circle from a two-ply piece of gauze, which is securely mounted on the pegboard using alligator clips. The AR overlays provide exact guidance on maintaining the correct cutting path and applying appropriate pressure to ensure a clean and accurate cut. Any deviation from the designated line results in penalties, reinforcing the importance of precision and control. The knot-tying modules focus on intracorporeal and extracorporeal techniques. Trainees are instructed to insert two needle drivers through the trocar ports and use them to tie secure surgical knots on a penrose drain. The AR software highlights critical points in the procedure, such as maintaining consistent suture tension and avoiding slippage, which are crucial for passing the FLS skills assessment.

The integrated AI system plays a critical role in analyzing the trainee's performance, utilizing computer vision and machine learning algorithms to evaluate metrics such as precision, speed, and stability. As the trainee performs each task, the system captures and analyzes video data, assessing whether the trainee's actions meet predefined standards. The AI provides real-time feedback, identifying errors like improper instrument angles, incorrect suture tension, or failure to follow the cutting path. This feedback is highly personalized, enabling the trainee to make immediate adjustments and refine their technique. Additionally, the AI classifies the trainee's skill level—beginner, intermediate, or expert—based on their performance metrics, providing a clear picture of progress and areas needing further improvement. This automated assessment mechanism not only accelerates skill acquisition but also ensures consistency in training.

To facilitate continuous improvement and long-term progress tracking, the training system includes a robust data management feature. Performance data is securely stored in the cloud, allowing trainees and instructors to access detailed records of each training session. This feature is particularly useful for remote coaching and assessment, as instructors can review video footage, evaluate performance trends, and provide targeted feedback without being physically present. The software also includes embedded instructional videos that trainees can access at any time for additional guidance, enhancing the self-directed nature of the training. This data-driven approach reduces the need for in-person proctors, making the training method scalable and efficient for institutions with large numbers of surgical residents. It ensures that trainees have ample opportunity to practice each task repeatedly, refining their skills in a realistic and structured environment.

Overall, this training method offers a comprehensive solution for mastering the FLS exam requirements, using a combination of tactile practice, visual guidance, and data-driven performance analysis. The modular structural frame, designed for portability and ease of assembly, ensures that training can be conducted in diverse environments, from hospitals to remote simulation centers. By using AR for immersive guidance and AI for objective performance evaluation, the system provides a highly effective and efficient training experience. It not only familiarizes trainees with the physical and technical demands of laparoscopic surgery but also equips them with the confidence and proficiency needed to pass the FLS exam. The integration of advanced technologies ensures that each training session is as realistic and clinically relevant as possible, fostering the development of essential surgical skills in a controlled, reproducible manner.

The described embodiments of the modular structural frame provide an advanced training solution for minimally invasive surgical procedures, effectively replicating the physical constraints and technical demands faced by surgeons. The frame's customizable design, featuring strategically positioned trocar ports, enhances realism by allowing trainees to practice tool handling and instrument insertion from various angles. Adjustable elements, such as the frame's height and ergonomic angles, ensure the setup can accommodate users of different statures while maintaining comfort and proper posture. These features combine to create a flexible and adaptive training environment that mirrors the real-world challenges encountered in laparoscopic surgery.

Integrated into the frame is a sophisticated light source that simulates the illumination conditions of an operating room, enhancing the overall realism of the training experience. The device also includes a dedicated platform for mounting a tablet computer, allowing for the seamless integration of augmented reality (AR) and artificial intelligence (AI) technologies. The AR system overlays visual instructions and performance metrics onto the live video feed from the tablet's camera, providing real-time, interactive guidance for various surgical tasks. By simulating exercises such as precision cutting, object manipulation, and knot tying, the AR interface ensures that trainees receive contextual and immediate feedback, facilitating the development of essential hand-eye coordination and instrument control.

AI technology further augments the training experience by analyzing the trainee's actions, assessing their precision, stability, and technique. This automated analysis offers immediate, personalized feedback, highlighting areas for improvement and classifying skill levels to help trainees track their progress. The inclusion of a robust data management system ensures that performance metrics are securely stored and accessible for both trainees and instructors, supporting remote coaching and long-term skill development. By blending advanced AR and AI functionalities with a meticulously designed modular frame, the invention provides a comprehensive and scalable training tool, enabling surgical residents to refine their skills efficiently and confidently prepare for high-stakes exams like the FLS.

What is claimed is:

1. A modular structural frame for a surgical training system, comprising:
a collapsible frame structure configured to form a partially enclosed volume, wherein the frame structure includes a front portion, a back portion, a pegboard base, and one or more mechanical hinges that enable the frame to transition between an assembled and a collapsed state for portability;
a plurality of trocar ports integrated into the frame structure, wherein the trocar ports are positioned to accommodate ipsilateral and contralateral instrument use, simulating ergonomic and spatial constraints encountered in laparoscopic surgical procedures;
a pegboard disposed at the base of the frame structure, configured to receive and secure various training modules for practicing surgical tasks;
an adjustable platform mounted on the frame structure, the platform configured to securely hold a tablet computer and align the tablet's camera with a dedicated port, facilitating video capture of a training area within the partially enclosed volume; and
a rechargeable light source integrated within the frame structure, the light source configured to provide illumination similar to that of a clinical environment.

2. The modular structural frame of claim 1, wherein the recharge light source is adjustable brightness and color settings controlled via the tablet computer to simulate various surgical lighting conditions.

3. The modular structure frame of claim 1, further comprising:
a reflective surface positioned within the frame structure, configured to provide an additional viewing angle for performance monitoring and assessment, wherein the reflective surface can be utilized by integrated augmented reality (AR) and artificial intelligence (AI) systems for analyzing and scoring the user's performance.

4. The modular structure frame of claim 1, wherein the location of the plurality of trocar ports are adjustable.

5. The modular structure frame of claim 1, wherein and angle between the front portion and the peg board is 60 degrees or less.

6. A non-transitory computer-readable medium storing instructions that, when executed by a processor of a tablet computer integrated into a surgical training system, cause the tablet computer to perform operations comprising:
capturing, via a camera of the tablet computer, real-time video footage of a user's actions within a partially enclosed volume defined by a collapsible modular structural frame, wherein the modular frame includes a pegboard base for securing various training modules and adjustable trocar ports for simulating ergonomic constraints of laparoscopic surgery;
overlaying, using augmented reality (AR) technology, visual instructions, graphical cues, and performance metrics onto the real-time video footage, wherein the AR overlays guide the user through a series of surgical tasks, including at least one or an object manipulation, precision cutting, or suture tying, while ensuring correct instrument positioning and handling; and
analyzing, using artificial intelligence (AI) algorithms, the captured video footage to assess the user's performance, including metrics such as precision, speed, and stability, and providing real-time, personalized feedback to the user based on the analysis.

7. The non-transitory computer-readable medium of 6, wherein the operations further comprise:
categorizing the user's proficiency level as beginner, intermediate, or expert based on performance metrics and storing the categorized data securely in a cloud-based system for tracking progress over time.

8. The non-transitory computer-readable medium of 6, wherein the operations further comprise:
providing access to embedded instructional videos and remote coaching features, wherein a user can receive additional guidance and instructors can review the user's performance data and offer feedback remotely.

9. The non-transitory computer-readable medium of 6, wherein the operations further comprise:
controlling a rechargeable light source integrated within the surgical training system, the light source configured to provide illumination similar to that of a clinical environment.

10. The non-transitory computer-readable medium of 6, wherein the operations further comprise:
utilizing a reflective surface positioned within the surgical training system, to obtain an additional viewing angle for performance monitoring and assessment;
scoring user's performance using additional viewing angle.

11. A method of training a surgeon in laparoscopic surgical skills using a modular surgical training system comprising a collapsible structural frame, a pegboard base for securing training modules, and a tablet computer, the method comprising:
configuring the modular structural frame by adjusting a height and positioning of trocar ports to simulate ergonomic constraints of a laparoscopic surgical environment, including options for ipsilateral and contralateral instrument insertion for both right- and left-handed users;
mounting the tablet computer on an adjustable platform integrated into the structural frame, aligning a camera of the tablet computer to capture real-time video footage of a training area within the frame; and
guiding the surgeon through a series of surgical tasks, including object manipulation, precision cutting, and suture tying, by overlaying augmented reality (AR) visual instructions, graphical cues, and performance metrics onto the real-time video feed displayed on the tablet computer.

12. The method of claim 11, further comprising:
capturing and analyzing, using artificial intelligence (AI) algorithms, a surgeon's performance metrics from the video footage, including precision, speed, and stability, and providing real-time feedback to the surgeon based on the analysis to enhance skill acquisition.

13. The method of claim 11, further comprising:
categorizing a surgeon's skill level as beginner, intermediate, or expert based on analyzed performance metrics, and storing performance data in a secure, cloud-based system for tracking progress and facilitating remote assessment.

14. The method of claim 11 further comprising:
enabling the surgeon to review embedded instructional videos for additional guidance and providing remote coaching capabilities for instructors to monitor and evaluate a surgeon's performance and offer targeted feedback.
